(19) United States
(12) Patent Application Publication
(10) Pub. No.: US 2018/0324519 A1
(43) Pub. Date: Nov. 8, 2018

(54) SOUND OUTPUT APPARATUS

(71) Applicant: MODA-INNOCHIPS CO., LTD., Ansan-Si, Gyeonggi-Do (KR)

(72) Inventors: Sung Chol PARK, Ansan-Si, Gyeonggi-Do (KR); Young Sul KIM, Seoul (KR); Sang Hun PARK, Seoul (KR); In Seob JEONG, Ansan-Si, Gyeonggi-Do (KR)

(21) Appl. No.: 15/773,994

(22) PCT Filed: Jun. 7, 2017
(86) PCT No.: PCT/KR2017/005907

§ 371 Date: May 4, 2018

(30) Foreign Application Priority Data
Jun. 10, 2016 (KR) 10-2016-0072555
Apr. 4, 2017 (KR) 10-2017-0043659

(51) Int. Cl. H04R 1/28; H04R 17/00; H04R 23/02; H04R 9/02; H04R 1/10

(52) U.S. Cl. CPC H04R 1/28; H04R 17/00; H04R 1/1058; H04R 9/02; H04R 23/02

(57) ABSTRACT

The present disclosure provides a sound output apparatus including a first sound output unit, a second sound output unit spaced a predetermined distance from the first sound output unit, at least one opening defined in the second sound output unit, and a housing for accommodating at least one of the first and second sound output units. Here, the housing has an external diameter that is 100% to 130% of a diameter of the second sound output unit.

### 1. TECHNICAL FIELD

The present disclosure relates to a sound output apparatus, and more particularly, to a sound output apparatus capable of improving output characteristics of an audio frequency band including a low-pitched sound band and a high-pitched sound band.

### 2. DESCRIPTION OF RELATED ART

In general, a piezoelectric element represents an element having characteristics mutually converting electrical energy and mechanical energy to each other. That is, the piezoelectric element generates a voltage when a pressure is applied (piezoelectric effect) and generates an increase or decrease in volume or length due to a pressure variation therein when a voltage is applied (inverse piezoelectric effect). The piezoelectric element includes a piezoelectric layer and an electrode disposed thereon and has a pressure varied in accordance with a voltage applied to the piezoelectric layer through the electrode.

The piezoelectric element may be used to manufacture various components such as a piezoelectric speaker and a vibration device. Among those, the piezoelectric speaker acoustically converts mechanical movement of the piezoelectric element by a vibration plate to generate a sound in a desired frequency band. The piezoelectric speaker has an advantage in that it is thinner and lighter than a conventional dynamic speaker and has a low power consumption. Accordingly, the piezoelectric speaker may be used for electronic devices such as a smartphone, which require a small size, a thin-type, and a light weight. However, the piezoelectric speaker has a disadvantage in that it has difficulties in listening to music for a long time because it has a strong high-pitched sound and a weak low-pitched sound.

Meanwhile, a dynamic speaker widely used for playing music uses a principle in which when a voice signal current flows in a voice coil in a magnetic field of a magnet, mechanical force acts on the voice coil in accordance with an intensity of the current to generate movement. However, the dynamic speaker is appropriate for realizing a low-pitched sound but relatively weak for realizing a high-pitched sound, and thus has a limitation to provide a high quality sound.

Accordingly, the applicant of the present disclosure applied for a patent for a sound output apparatus in which the piezoelectric speaker and the dynamic speaker are coupled to each other (Korean Patent Application No. 2015-0171719). In the sound output apparatus that is applied for a patent by the applicant, the piezoelectric speaker and the dynamic speaker are spaced apart from each other in a housing, and a discharge hole is defined in a predetermined area of the housing to discharge an output sound from the dynamic speaker. Accordingly, sounds respectively outputted from the piezoelectric speaker and the dynamic speaker are not mixed inside the housing and are mixed outside the housing. That is, the sound of the piezoelectric speaker is directly outputted, the sound of the dynamic speaker is outputted through the discharge hole, and then the two sounds are mixed outside the housing.

However, the sound output apparatus has a limitation in reducing its size. That is, since the sound of the piezoelectric speaker is directly outputted, but the discharge hole needs to be defined to output the sound of the dynamic speaker, a total size, i.e., a size of housing is limited to be reduced. Alternatively, as the size of the housing is reduced, the sizes of the piezoelectric speaker and the dynamic speaker may be reduced. However, in this case, sound characteristics are degraded.

### PRIOR DOCUMENTS

### Patent Documents

Korean Patent Publication No. 2014-0083860

Korean Patent Registration No. 10-1212705

### Technical Problem

The present disclosure provides a sound output apparatus having all advantages of a piezoelectric speaker and a dynamic speaker.

The present disclosure also provides a sound output apparatus capable of reducing a total size thereof and improving all of low-pitched sound characteristics and high-pitched sound characteristics.

The present disclosure also provides a sound output apparatus capable of maintaining a size of a piezoelectric speaker and reducing a size of a housing to maintain sound characteristics and reduce a total size

### Technical Solution

In accordance with an exemplary embodiment, a sound output apparatus includes: a first sound output unit; a second sound output unit spaced a predetermined distance from the first sound output unit; at least one opening defined in the second sound output unit; and a housing for accommodating at least one of the first and second sound output units, in which the housing has an external diameter that is 100% to 130% of a diameter of the second sound output unit.

The first sound output unit may include a dynamic speaker, and the second sound output unit may include a piezoelectric speaker including a piezoelectric element and a vibration plate.

The housing may have an external diameter that is 100% to 130% of a diameter of the piezoelectric element.

The vibration plate may have a diameter equal to or less than the external diameter of the housing.

The external diameter of the housing may be less than 13 mm.

The opening may have a diameter that is 3% to 70% of that of the piezoelectric element.

The piezoelectric element may include a base, a plurality of piezoelectric layers disposed on at least one surface of the base, a plurality of internal electrodes disposed between the plurality of piezoelectric layers, and an external electrode disposed on the outside so as to be connected to the plurality of internal electrodes.

The base may have a thickness that is one-third to one-one hundred fiftieth of that of the piezoelectric element.

Each of the piezoelectric layers may have a thickness of 2 μm to 50 μm.

The piezoelectric layer may be laminated in two layers to fifty layers.

Each of the piezoelectric layers may have a thickness that is one-third to one-one hundredth of that of the piezoelectric element.

Each of the piezoelectric layers may have a thickness equal to or greater than that of each of the internal electrodes.

The piezoelectric layer may include at least one pore.

The internal electrode may have at least one area having a different thickness.

The internal electrode may have a surface area that is 10% to 97% of that of the piezoelectric layer.

The piezoelectric layer may include a seed composition.

The piezoelectric layer may include an oriented base material composition made of a piezoelectric material having a perovskite crystal structure and a seed composition made of an oxide distributed in the oriented base material composition and having a general formula of ABO₃ (A indicates a divalent metallic element, and B indicates a tetravalent metallic element)

The seed composition is oriented with a length of 1 μm to 50 μm in at least one direction.

A space between the first and second sound output units may have a volume of 10 mm³ to 100 mm³.

The sound output apparatus may further include a weight member disposed on at least one area of the second sound output unit.

The weight member may further include a mesh disposed on an area corresponding to the opening.

The sound output apparatus may further include a coating layer disposed on at least a portion of at least one of the first sound output unit, the second sound output unit, and the housing.

### Advantageous Effects

The sound output apparatus in accordance with exemplary embodiments includes the dynamic speaker and the piezoelectric speaker, which are spaced a predetermined distance from each other in the housing. Accordingly, as the dynamic speaker having excellent low-pitched sound characteristics and the piezoelectric speaker having high-pitched sound characteristics are disposed in the single housing, the sound characteristics in the audio frequency band may be improved.

Also, as at least one opening is defined in the predetermined area of the piezoelectric speaker, the sound outputted from the dynamic speaker is outputted through the opening. Accordingly, the sounds respectively outputted from the dynamic speaker and the piezoelectric speaker are mixed outside the housing to further improve the sound quality.

In addition, as the opening is defined in the predetermined area of the piezoelectric speaker, the opening may not be defined in the housing, and thus, the housing may be reduced in size. Thus, the piezoelectric speaker may maintain the size thereof to maintain the sound characteristics and reduce the size of the housing, and thus, the total size of the sound output apparatus may be reduced.

Meanwhile, the sound output apparatus in accordance with the exemplary embodiment may be realized as a speaker and an earphone In particular, the sound output apparatus in accordance with the exemplary embodiment may be realized as an earphone to perform the miniaturization of the earphone.

### BRIEF DESCRIPTION OF THE DRAWINGS

Exemplary embodiments can be understood in more detail from the following description taken in conjunction with the accompanying drawings, in which:

FIGS. 1 to 3 is an exploded perspective view, a coupling perspective view, and a coupling cross-sectional view of a sound output apparatus in accordance with an exemplary embodiment;

FIG. 4 is a perspective view illustrating a modified example of the sound output apparatus in accordance with the exemplary embodiment;

FIG. 5 is a perspective view in accordance with an exemplary embodiment of a piezoelectric element used in an exemplary embodiment;

FIGS. 6 through 9 are cross-sectional views in accordance with an exemplary embodiment of the piezoelectric element used in an exemplary embodiment;

FIGS. 10 and 11 are graphs showing sound characteristics in accordance with a thickness and the number of lamination of a piezoelectric layer of a piezoelectric element;

FIGS. 12 through 14 are views for explaining a characteristics of a piezoelectric ceramic sintered body used in an exemplary embodiment;

FIGS. 15 through 17 are views for explaining an exemplary embodiment and a comparative example of the piezoelectric ceramic sintered body used in an exemplary embodiment;

FIGS. 18 and 19 are an exploded perspective view and a coupling perspective view of a sound output apparatus in accordance with another exemplary embodiment;

FIGS. 20 and 21 are an exploded perspective view and a coupling perspective view of a sound output apparatus in accordance with still another exemplary embodiment;

FIG. 22 is a graph illustrating characteristics of a sound output apparatus in which an opening is defined in a piezoelectric speaker in accordance with exemplary embodiments and a sound output apparatus in which a discharge hole is defined in a housing in accordance with a comparative example;

FIG. 23 is a graph showing sound characteristics of a piezoelectric speaker in accordance with a volume of an inner space of a sound output apparatus.

FIGS. 24 through 26 are an exploded perspective view, a coupling perspective view, and a coupling cross-sectional view of a sound output apparatus in accordance with even another exemplary embodiment;

FIG. 27 is a schematic plan view of the sound output apparatus in accordance with even another exemplary embodiment; and

FIG. 28 is a graph showing characteristics of the sound output apparatus in accordance with even another exemplary embodiment and the sound output apparatus in accordance with the comparative example.

### DETAILED DESCRIPTION OF EMBODIMENTS

Hereinafter, specific embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

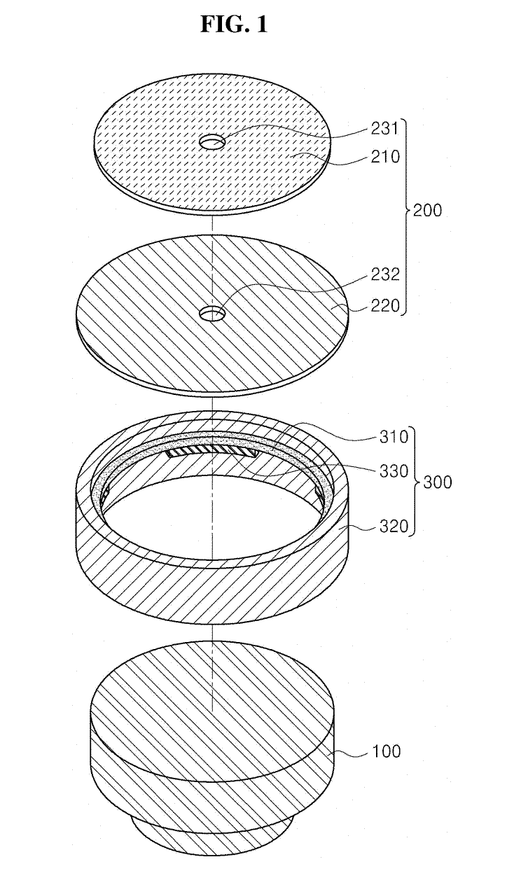

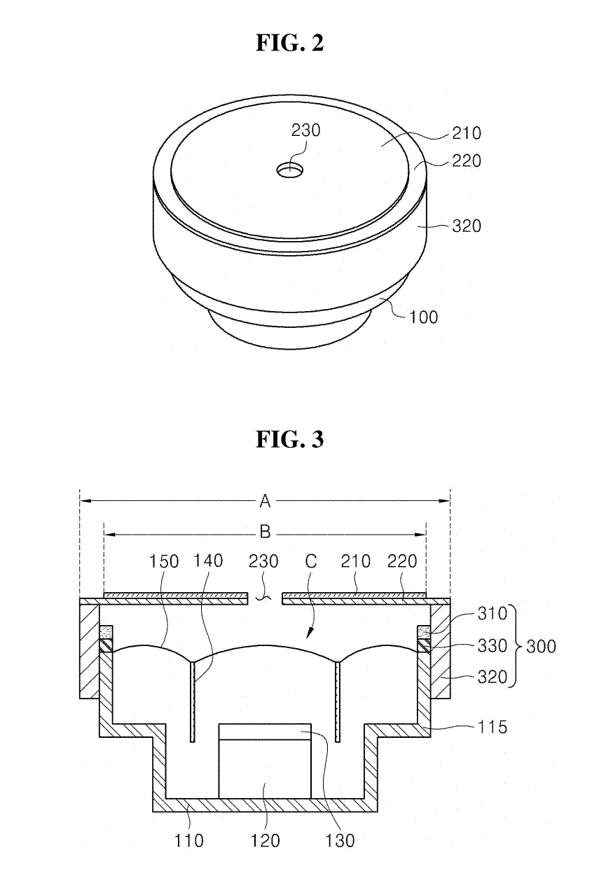

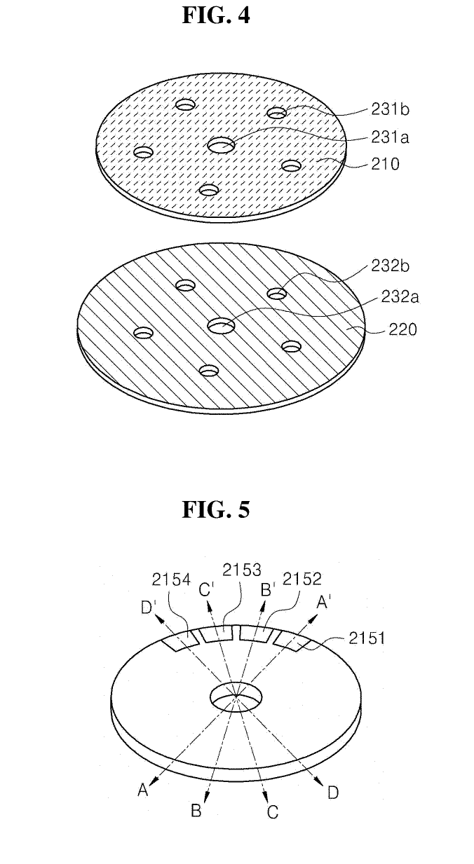

FIG. 1 is an exploded perspective view of a sound output apparatus in accordance with an exemplary embodiment, FIG. 2 is a perspective view illustrating a coupled state, and FIG. 3 is a cross-sectional view of the coupled state. Also, FIG. 4 is a perspective view of a modified example of a first sound output unit of the sound output apparatus in accordance with the exemplary embodiment

Referring to FIGS. 1 to 4, the sound output apparatus in accordance with the exemplary embodiment may include a first sound output unit 100, a second sound unit 200 disposed on the first sound output unit 100, and a housing 300 accommodating at least one of the first sound output unit 100 and the second sound output unit 200. That is, the first and second sound output units 100 and 200 may be spaced a predetermined distance from each other in the housing 300. Here, the first sound output unit 100 may include a dynamic speaker including a voice coil 140 and a vibration member 150 to vibrate in accordance with current variation of the voice coil 140, and using this, allow the vibration member 150 to vibrate, thereby outputting a sound. Also, the second sound output unit 200 may include a piezoelectric speaker including a piezoelectric element 210 and a vibration plate 220 to acoustically convert mechanical movement by the vibration plate 220.

1. First Sound Output Unit

The first sound output unit 100 may have an approximately circular shape having a predetermined thickness. As illustrated in FIG. 3, the first sound output unit 100 may include a yoke 110 having an accommodation space and a frame 115, a magnet 120 disposed in the accommodation space in the yoke 110, a plate 130 disposed on the magnet 120, a voice coil 140 disposed between the yoke 110 and the magnet 120 in the frame 115, a vibration member 150 disposed above the plate 130, of which an edge is fixed to the frame 115, and to which the voice coil 140 is fixed.

The yoke 110 has an approximately circular shape having a predetermined height, and the fame 115 is disposed above the yoke 110 and has an approximately circular shape having a predetermined height. Here, the frame 115 may have a height and a width greater than those of the yoke 110. Alternatively, the height of the frame 115 may be equal to or less than that of the yoke 110. Here, the frame 115 may have an upper edge contacting at least one area of the housing 300 and be accommodated in the housing 300. Also, the magnet 120 and the plate 130 may be accommodated in the yoke 110, the voice coil 140 is accommodated in the frame 115, and the vibration member 150 may be disposed on the frame 115 to cover the frame 115. The yoke 110 and the frame 115 serve to induce a magnetic field provided by the magnet 120 to the plate 130 so that the magnetic field provided by the magnet 120 is maximally affected to the voice coil 140.

The magnet 120 is fixed to a bottom surface of the yoke 110. That is, the magnet 120 has a bottom surface contacting and fixed to the inner bottom surface of the yoke 110. The magnet 120 may have a shape corresponding to an inner shape of the yoke 110. For example, the inside of the yoke 110 has an approximately cylindrical shape, and the magnet 120 has an approximately circular column shape. Here, the magnet 120 may have a height equal to or less than that of the yoke 110. Also, the magnet 120 may have a diameter equal to or less than that of the yoke 110. Accordingly, the magnet 120 may be spaced a predetermined distance from an inner wall of the yoke 110 in the yoke 110.

The plate 130 is disposed on a top surface of the magnet 120. The plate 130 may have the same shape as a planar shape of the magnet 120. That is, the plate 130 may have a circular plate shape having a predetermined thickness. Here, the plate 130 may have a diameter less than that of the yoke 110 and equal to or greater than that of the magnet 120. Accordingly, the plate 130 may have an outer surface spaced a predetermined distance from an inner surface of the yoke 110. Also, a height of the magnet 120 and the plate 130 disposed thereon may be equal to that of the yoke 110. That is, top surfaces of the plate 130 and the yoke 110 may provide the same plane. The plate 130 allows lines of magnetic force generated by the magnet 120 to be focused toward the voice coil 140.

The voice coil 140 may be attached to a bottom surface of the vibration member 150 and disposed between the yoke 110 and the magnet 120 in the frame 115. For example, the voice coil 140 is disposed between the plate 130/the magnet 120 and the yoke 110 to surround a portion of the height of the plate 130 and the magnet 120 and has an upper portion attached to a bottom surface of the vibration member 150. As the voice coil 140 provides a magnetic field continuously varied by a continuously varying and inputted electric signal, the voice coil 140 is vibrated by interaction caused by an interference with the magnetic field provided by the magnet 120.

The vibration member 150 has an edge fixed to the inner surface of the frame 115 to cover an upper portion of the frame 115. Also, the vibration member 150 may have at least one protruding area. For example, the vibration member 150 may have a shape of which an area corresponding to a central area of the frame 115 is highest and gradually decreasing in height from the area to the outside. That is, the vibration member 150 may have a protruding shape gradually decreasing in height from an area corresponding to a center of the magnet 120 and the plate 130 to the outside. Also, the voice coil 140 may be fixed to a lowest area of the vibration member 150

The first sound output unit 100 constitutes a closed circuit in which a magnetic field generated from the magnet 120 is moved to the yoke 110 therebelow through the plate 130 disposed on the magnet 120 and then moved again to the magnet 120. The magnetic field moved to a space between the plate 130 and the yoke 110 therebelow pulls or pushes the voice coil 140 in accordance with a polarity of magnetic force of the voice coil 140 when current is applied to the voice coil 140 and thus the voice coil 140 becomes magnetic. That is, when the polarity of magnetic force of the voice coil 140 is equal to that of the plate 130 and the yoke 110 therebelow, mutual repulsion occurs to push the voice coil 140, so that the voice coil 140 moves forward. In addition, when the polarity of magnetic force of the voice coil 140 is different from that of the plate 130 and the yoke 110 therebelow, mutual attraction occurs to pull the voice coil 140 backward. As described above, when the voice coil 140 moves, the vibration member 150 fixed to the voice coil 140 moves back and force to vibrate the air, thereby generating a sound.

2. Second Sound Output Unit

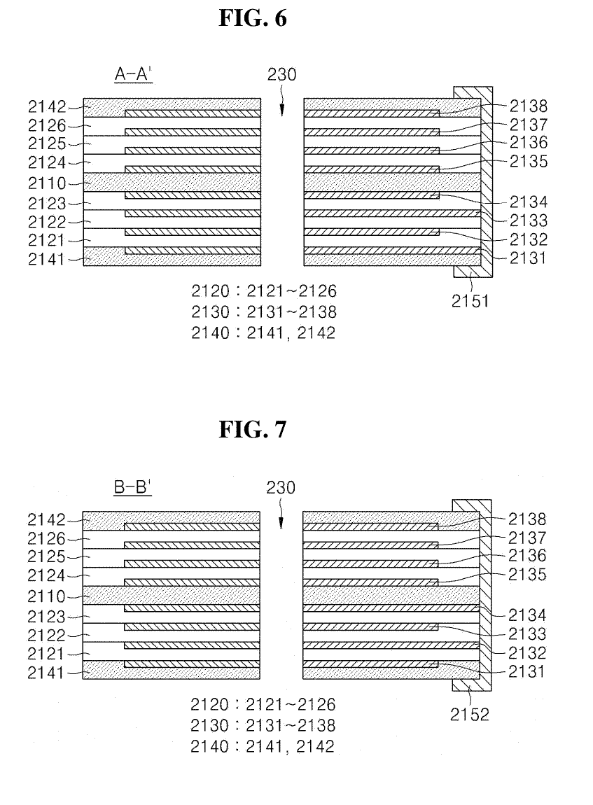

The second sound output unit 200 may include a piezoelectric element 210, a vibration plate 220, at least one opening 230 passing through a predetermined area of the second sound output unit 200. That is, the opening 230 may be defined to pass through the predetermined area of each of the piezoelectric element 210 and the vibration plate 220. The piezoelectric element 210 may have, e.g., a circular plate shape having a predetermined thickness. Alternatively, the piezoelectric element 210 may have various shapes such as a square shape, a rectangular shape, an oval shape, and a polygonal shape in addition to the circular shape. The piezoelectric element 210 may include a base and a piezoelectric layer provided on at least one surface of the base. The piezoelectric element 210 will be described in more detail with reference to FIGS. 6 and 7 and the like. The piezoelectric element 210 is attached to at least one surface of the vibration plate 220 by using adhesive. Here, the piezoelectric element 210 may be attached to a central portion of the vibration plate 220 to allow both sides of the vibration plate 220 to be remained with the same length as each other. Also, the piezoelectric element 210 may be attached to a top surface or a bottom surface of the vibration plate 220. Alternatively, the piezoelectric element 210 may be attached to each of the top and bottom surfaces of the vibration plate 220. That is, although the piezoelectric element 210 is attached to the top surface of the vibration plate 220 in the present embodiment, the piezoelectric element 210 may be attached to the top surface of the vibration plate 220 or each of the top and bottom surfaces of the vibration plate 220. Here, the piezoelectric element 210 and the vibration plate 220 may be fixed to each other through various methods in addition to adhesion. For example, the vibration plate 220 and the piezoelectric element 210 are stuck to each other by using a stick agent, and side surfaces of the vibration plate 220 and the piezoelectric element 210 are attached to each other by using adhesive. Meanwhile, an electrode pattern (not shown) to which a driving signal is applied may be provided on an upper portion of one surface of the piezoelectric element. At least two electrode patterns may be provided to be spaced from each other and connected to a connecting terminal (not shown) to receive an acoustic signal from an electronic device such as an auxiliary mobile device through the connecting terminal.

The vibration plate 220 may have an approximately circular plate shape and greater in size than the piezoelectric element 210. Also, the vibration plate 220 may have an opening defined in a central portion thereof, and the piezoelectric element 210 may be provided on the opening. The piezoelectric element 210 may be attached to a top surface of the vibration plate 220 using adhesive. The vibration plate 220 may be manufactured by using metal, plastic, and the like and by stacking different kinds of materials to have a double structure. Also, the vibration plate 220 may be made of a polymer-based or pulp-based material. For example, the vibration plate 220 may be made of a resin film. That is, the vibration plate 200 may be made of a material having a large loss coefficient with a Young's modulus of 1 MPa to 10 MPa such as an ethylene propylene rubber-based material and a styrene butadiene rubber-based material. Also, the vibration plate 220 may have a lower edge contacting an inner surface of the housing 300. That is, the vibration plate 220 and the piezoelectric element 210 attached to a central portion thereof may be disposed in an inner space of the housing 300. The second sound output unit 200 may be driven in accordance with a predetermined signal and output sound having excellent characteristics of high frequency sound Here, the piezoelectric element 210 has a diameter equal to or less than that of the vibration plate 220.

The opening 230 may be defined in at least one predetermined area of the second sound output unit 200. That is, at least one opening 230 may be defined to pass through the predetermined area of each of the piezoelectric element 210 and the vibration plate 220. That is, the opening 230 may include a first opening 231 defined in at least one area of the piezoelectric element 210 and a second opening 232 defined in at least one area of the vibration plate 220. The opening 230 may be defined in accordance with a shape of each of the piezoelectric element 210 and the vibration plate 220. For example, the opening 230 may have a circular shape. However, the opening 230 may have a shape different from that of each of the piezoelectric element 210 and the vibration plate 220. That is, the opening 230 may have various shapes such as a square shape, a rectangular shape, an oval shape, and a polygonal shape. Also, the first opening 231 and the second opening 232 may be defined in, e.g., the central area of each of the piezoelectric element 210 and the vibration plate 220 and overlap each other. That is, the first opening 231 and the second opening 232 may have the same size as each other and overlap each other. Alternatively, the first and second openings 231 and 232 may be different in size, and preferably, the central areas thereof may be overlapped with each other. That is, although the vibration plate 220 may be greater in size than the piezoelectric element 210, and the second opening 232 defined in the vibration plate 220 may be greater than the first opening 231 defined in the piezoelectric element 210, the first opening 231 may be defined to overlap the second opening 232. Accordingly, when the first and second openings 231 and 232 respectively defined in the piezoelectric element 210 and the vibration plate 220 are different in size, the opening 230 has a smaller size of that of each of the first and second openings 231 and 232. Alternatively, the opening 230 may be defined to a different area except for the central area of each of the piezoelectric element 210 and the vibration plate 220. Also, the opening 230 may be defined in plurality. For example, as illustrated in FIG. 4, a plurality of first openings 231a and 231b may be defined in the central area and a surrounding area of the piezoelectric element 210, and a plurality of second openings 232a and 232b may be defined in the central area and a surrounding area of the vibration plate 220. Here, at least one of the plurality of openings 230 may be different in size. That is, at least one of the plurality of first openings 231 defined in the piezoelectric element 210 may be different in size, and at least one of the plurality of second openings 232 defined in the vibration plate 220 may be different in size. For example, as illustrated in FIG. 4, the first and second openings 231a and 232a defined in the central area may be greater than at least one first and second opening 231b and 232b, and at least one first and second opening 231b and 232b defined in the surrounding area may have the same size as each other or at least one thereof may be different in size. Here, each of the plurality of first openings 231a and 231b and the plurality of the second openings 232a and 232b may overlap each other. Alternatively, the openings 230 respectively define din the piezoelectric element 210 and the vibration plate 220 and overlapping each other desirably have the same size as each other. Each of the openings 230 may have a size of, e.g., 0.09% to 50% of a surface area of the piezoelectric element 210. That is, at least one opening 230 may have a size of 0.09% to 50% of the surface area of the piezoelectric element 210. Here, when the opening 230 is provided in plurality, a total surface area of the plurality of openings 230 may have a size of 0.09% to 50% of the surface area of the piezoelectric element 210. Alternatively, the opening 230 may have a diameter that is 3% to 70% of that of each of the piezoelectric element 210 and the vibration plate 220. That is, when the piezoelectric element 210 has a circular shape, and the opening 230 also has a circular shape, the opening 230 may have a diameter that is 3% to 70% of that of the piezoelectric element 210. For example, when the piezoelectric element 210 has a diameter of 10 mm, the opening 230 may have a diameter of 0.3 mm to 7 mm. Alternatively, when the opening 230 has a polygonal shape, the opening 230 may have an average diameter that is 3% to 70% of a diameter B of the piezoelectric element 210. Meanwhile, the opening 230 defined in the vibration plate 220 may be defined in the same position with the same size as the opening 230 defined in the piezoelectric element 210. Alternatively, the opening 230 defined in the vibration plate 220 may be defined greater or less in size than the opening 230 defined in the piezoelectric element 220. When the opening 230 has a size less than 0.09% or a diameter less than 3% of the surface area or the diameter of the piezoelectric element 210, sound characteristics may be reduced because an amount of the sound outputted from the first sound output unit 100 and discharged through the opening 230 is small. When the opening 230 has a size greater than 50% or a diameter greater than 70%, piezoelectric characteristics of the piezoelectric element 210 and vibration characteristics of the vibration plate 220 may be hindered to decrease the sound characteristics. As the opening 230 is defined in the second sound output unit 200, the sound outputted from the first sound output unit 100 may be outputted through the opening 230. Accordingly, the sound outputted from the second sound output unit 200 and the sound outputted from the first sound output unit 100 and outputted through the opening 230 are mixed outside the housing, so that the sound characteristics in an audio frequency band may be further improved.

Meanwhile, a coating layer (not shown) may be further provided on at least a portion of the second sound output unit 200. The coating layer may be made of parylene and the like. The parylene may be provided on a top surface and a side surface of the piezoelectric element 210 and a top surface and a side surface of the vibration plate 220 exposed by the piezoelectric element 210 in a state in which the piezoelectric element 210 is attached on the vibration plate 220. That is, the pyrylene may be provided on the top and side surfaces of the piezoelectric element 210 and the vibration element 220. Also, the parylene may be provided on the top and the side surfaces of the piezoelectric element 210 and the top, side, and bottom surfaces of the vibration plate 220 in a state in which the piezoelectric element 210 is attached on the vibration plate 220. That is, the parylene may be provided on the top, side, and bottom surfaces of each of the piezoelectric element 210 and the vibration element 220. Also, when the piezoelectric element 210 is provided on the opening defined in the central portion of the vibration element 220, the parylene may be provided on the top and side surfaces and the bottom surface, which is exposed by the opening, of the piezoelectric element and, at the same time, provided on the top, side, and bottom surfaces of the vibration element 220. As the parylene is provided on at least one surface of the piezoelectric element 210 and the vibration plate 220, moisture may be prevented from being introduced into the second sound output unit 200, and thus oxidation may be prevented. In addition, eccentric vibration generated by using a vibration element made of a thin material such as a polymer may be improved, and a response speed may be improved due to increase in hardness of the vibration element to relieve deep acoustic characteristics and stabilize upper register. Also, as a resonant frequency may be adjusted in accordance with a coating thickness of the parylene, a sound pressure improvement point is adjustable. Alternatively, the parylene may be applied on only the piezoelectric element 210, i.e., on the top, side, and bottom surfaces of the piezoelectric element 210. In addition, the parylene may be applied on FPCB coupled to the piezoelectric element 210 to supply power to the piezoelectric element 210. As the parylene is provided on the piezoelectric element 210, moisture may be prevented from being introduced into the piezoelectric element, and thus oxidation may be prevented. Also, as formation thickness is adjusted, the resonant frequency may be adjusted. Meanwhile, when the parylene is provided on the FPCB, noise generated from a joint between the FPCB, a solder, and an element may be improved. The above-described parylene may be applied with different thicknesses in accordance with materials and features of the piezoelectric element or the vibration element. For example, the parylene may have a thickness less than that of the piezoelectric element or the vibration element, e.g., a thickness of about 0.1 μm to about 10 μm. For example, to apply the parylene, when the parylene is vaporized by being first-heated in a vaporizer and converted into a dimmer state, and then thermally decomposed into a monomer state by being second-heated and cooled, the parylene may be converted from the monomer state into the polymer state and applied at least one surface of the piezoelectric vibration member 2. Meanwhile, the waterproof layer such as the parylene may be applied to at least a portion of the first sound output unit 100 and at least a portion of the housing 200 as well as at least a portion of the second sound unit 200.

3. Housing

The housing 300 may have an approximately cylindrical shape. That is, the housing 300 may have an approximately circular container shape that is opened in at least one direction. For example, the housing 300 may have a vertically through-type or a shape having a closed inner predetermined area and upper and lower portions thereof are opened. The vertically through-type housing 300 may include a first member 310 having an approximately ring shape having a predetermined thickness and a second member 320 provided in upward and downward directions from a predetermined area of the first member 310. That is, the second member 320 may be provided to surround the ring shaped first member 310. Alternatively, when the first member 310 has a circular plate shape, the housing 300 having a predetermined space on upper and lower portions from the first member 310 may be realized by the second member 320 surrounding the first member 310. Meanwhile, the second member 320 may have a cut area (not shown) vertically defined in a predetermined area thereof. For example, the second member 320 may surround the first member 310 and be spaced apart from the predetermined area. In the cut area, a signal line for providing a signal to the second sound output unit 200 may be provided. Here, the cut area of the second member 320 may have a width, i.e., a distance between ends of the second member 320, which is 1% to 5% of a width of the second member 320. That is, in the present invention, while the cut area is defined to provide a signal supply line connected to the second sound output unit 200, a discharge hole for discharging sound outputted from the first sound output unit 100 is not defined. As a result, the second member 320 may seal the inner space of the housing 300. Alternatively, the second member 320 may have a predetermined hole defined in a side surface thereof instead of the cut area. That is, the hole may be defined in the second member 320, and the signal line may be connected thereto through the hole. Alternatively, the signal line may be connected in various manners. For example, the signal line may be connected between the second sound output unit 200 and the second member 320.

Also, a protruding part 330 may be provided inside the second member 320. That is, the protruding part 330 may protrude inward from an inner wall of the second member 320. Also, the first member 310 may be seated on the protruding part 330. The first member 310 and the second member 320 may be separately manufactured and then attached to each other so that the first member 310 is seated on the protruding part 330 of the second member 320 or may be integrated with each other. Alternatively, the protruding part 330 may not be provided, and the first member 310 and the second member 320 may be attached to each other or integrated with each other so that an outer side of the first member 310 contacts an inner side of the second member 320. In the housing 300, the second sound output unit 200, i.e., the vibration plate 220 of the piezoelectric speaker, may contact the top surface of the second member 320, and the first sound output unit 100, i.e., the dynamic speaker, may contact the bottom side of the protruding part 330. That is, the first sound output unit 100 and the second sound output unit 200 may be spaced apart from each other with the first member 310, the protruding part 330, and the second member 320 disposed above the first member 310. Alternatively, when the protruding part 330 may not be provided inside the second member 320, and the first member 310 contacts the inner wall of the second member 320, the vibration plate 220 may contact the top surface of the second member 320, and the first sound output unit 100 may contact the bottom surface of the first member 310. That is, the first sound output unit 100 and the second sound output unit 200 may face each other and be spaced as many as thicknesses of the first member 310 and the second member 320 thereabove. Accordingly, since the vibration plate 220 is disposed on the second member 320, the vibration plate 220 may have a diameter that is the same as an external diameter A of the second member 320. That is, the vibration plate 220 may have the diameter that is the same as the external diameter A of the housing 300. Here, the piezoelectric element 210 may have a diameter B that is less than the external diameter A of the housing 300 and an internal diameter of the housing 300. As the sound from the second sound output unit 200 is directly discharged to the outside, and the sound from the first sound output unit 100 is discharged through the opening 230 of the second sound output unit 200, the two sounds are mixed outside the housing 300.

Meanwhile, a predetermined space may be defined between the first and second sound output units 100 and 200. That is, as illustrated in FIG. 3, an inner space C may be defined between the first and second sound output units 100 and 200, which face each other, and the second member 320 of the housing 300 surrounding side surfaces therebetween. The inner space C may have a volume of 10 mm³ to 100 mm³, desirably 20 mm³ to 80 mm³, more desirably 30 mm³ to 70 mm³. Here, the volume of the inner space C may be adjusted by adjusting a position of the first member 310. Alternatively, when the protruding part 330 is further provided in the housing 300, the volume of the inner space C may be adjusted by adjusting positions of the first member 310 and the protruding part 330. The second sound output unit 200 may have a resonant frequency adjusted in accordance with the volume of the inner space C. That is, as the volume of the inner space C increases, the resonant frequency of the second sound output unit 200 may be shifted to a low frequency band. However, since, as the volume of the inner space C increases, the size of the housing 300 increases, and accordingly, the size of the sound output apparatus increase, the inner space C may have a volume of 10 mm³ to 100 mm³ while not increasing the size of the housing.

The above-described sound output apparatus may be manufactured as a speaker, an amplifier, and an earphone for a vehicle speaker or a speaker for family use. Desirably, the sound output apparatus in accordance with an exemplary embodiment may be manufactured as an earphone such as a kernel-type earphone, and in this case, the housing 300 may have an approximate size that is insertable into an ear. Here, the sound output apparatus may be inserted into the ear from the second sound output unit 200. Accordingly, the sound from the second sound output unit 200 is outputted first, and then sound from the first sound output unit 100 is outputted through the opening 230, so that the two sounds are mixed in an ear. Also, in accordance with an exemplary embodiment, the first sound output unit 100 and the second sound output unit 200 may be inserted into and spaced apart from each other in the housing 300, or a portion of the housing 300 into which the first sound output unit 100 is inserted and another portion of the housing 300 into which the second sound output unit 200 is inserted are coupled to each other to manufacture the sound output apparatus. For example, the sound output apparatus may be manufactured in such a manner that a thickness of the first member 310 is divided in half, the first sound output unit 100 is inserted inside the first housing, which provides a portion of the second member 320 to surround a first thickness of a lower side of the first member 310, the second sound output unit 200 is inserted inside the second housing, which provides a portion of the second member 320 to surround a second thickness of an upper side of the first member 310, and then the first and second housing are coupled to each other.

Meanwhile, the sound output apparatus in accordance with an exemplary embodiment may be driven at a low voltage of 0.1 V to 5.0 V, desirably, 0.1 V to 2.0 V, more desirably, 0.1V to 0.5V. Especially, when applied to an earphone, the apparatus may be driven at a low voltage of 0.1 V to 0.2 V, desirably 0.1 V to 0.18 V. That is, the piezoelectric element 210 of the second sound output unit 200 is formed by stacking a plurality of piezoelectric layers with an inner electrode therebetween. Here, since the piezoelectric layer has a thickness of 1 μm to 30 μm, the second sound output unit 200 may be driven at the low voltage. While a conventional piezoelectric speaker has a driving voltage equal to or greater than 5V, the second sound output unit 200 in accordance with an exemplary embodiment may be driven at the low voltage of 0.1V to 0.5V without using an additional amplifier for a piezoelectric speaker, and accordingly, coupled to a dynamic speaker and driven at the low voltage. Also, in the sound output in accordance with an exemplary embodiment, the first and second sound output units 100 and 200 may be driven at the same time by applying the same signal thereto. That is, as a signal provided from a signal source is directly applied to the first sound output unit 100, passes through a high band filter, and is applied to the second sound output unit 200, signals in low frequency and high frequency bands may be respectively applied to the first and second sound output units 100 and 200. However, in accordance with an exemplary embodiment, the same signal may be simultaneously applied to the first and second sound output units 100 and 200.

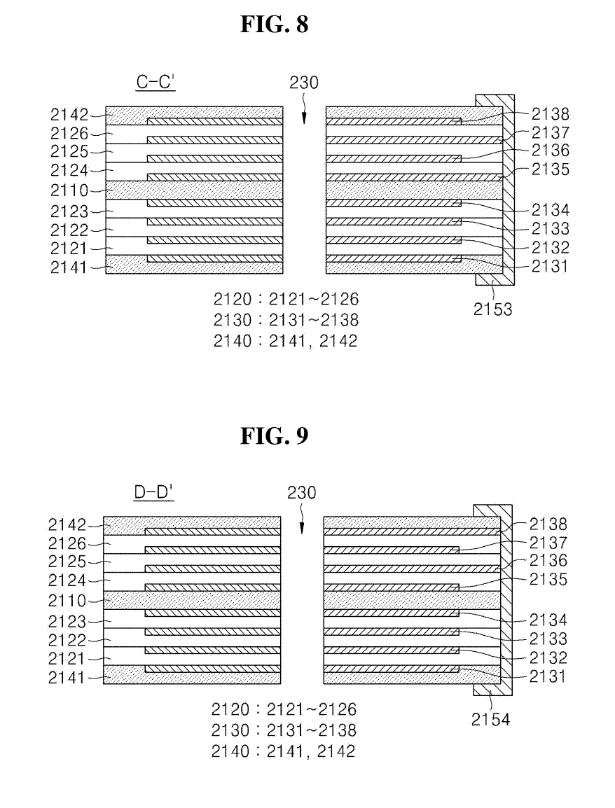

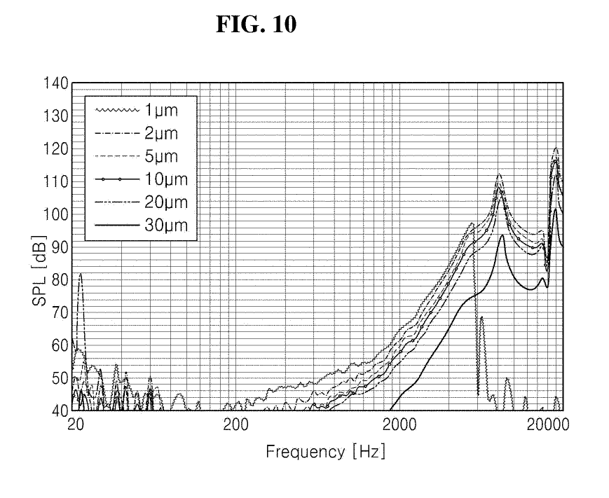

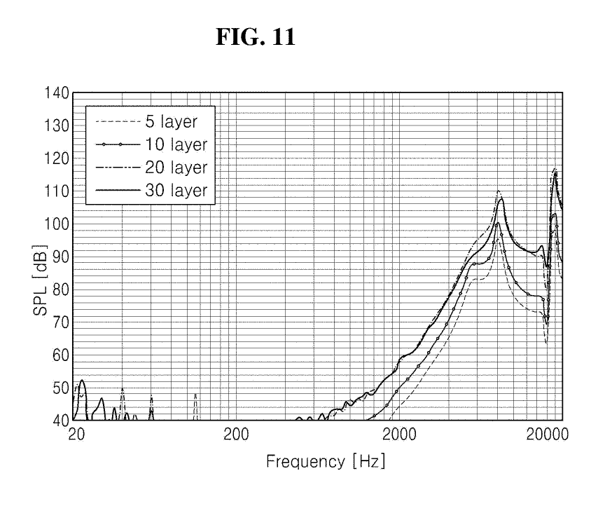

Next, the piezoelectric element 210 used as the second sound output unit 200 of the present invention will be described below in detail with reference to the drawings. FIG. 5 is a perspective view of a piezoelectric element in accordance with an exemplary embodiment, and FIGS. 6 to 9 are cross-sectional views taken along lines A-A′, B-B′, C-C′, and D-D′ in FIG. 5. Also, FIGS. 10 and 11 are views for explaining a piezoelectric element in accordance with another exemplary embodiment.

2.1. One Example of Piezoelectric Element

As illustrated in FIG. 5, the piezoelectric element 210 may have a plate shape having a predetermined thickness. For example, the piezoelectric element 210 may have a thickness of, e.g., 0.1 mm to 1 mm. However, the piezoelectric element 210 may have a thickness less or greater than the above-described thickness range in accordance with a size of the sound output apparatus and/or a size of the second sound output unit. Alternatively, the piezoelectric element 210 may have a circular shape having a diameter of, e.g., 4 mm to 15 mm. Here, the piezoelectric element 210 has a diameter equal to or less than that of the vibration plate 220. Alternatively, the piezoelectric element 210 may have various shapes such as a rectangular shape and an oval shape and a shape different from that of the vibration plate 220. For example, the vibration plate 220 may have a rectangular shape and the piezoelectric element 210 may have a circular shape, or the vibration plate 220 may have a circular shape and the piezoelectric element 210 may have a rectangular shape. When the piezoelectric element 210 and the vibration plate 220 have different shapes, the piezoelectric element 210 is desirably less in size than the vibration plate 220 so that at least one area of the piezoelectric element 210 is not deviated to the outside from the vibration plate 220. Meanwhile, the piezoelectric element 210 may have various shapes and a surface area of 10 mm² to 200 mm². The surface area may be a total surface area of the piezoelectric element 210 including the opening 230. Also, the surface area of the piezoelectric element 210 excluding the opening may be 4 mm² to 100 mm².

As illustrated in FIGS. 6 to 9, the piezoelectric element 210 may include a base 2110, at least one piezoelectric layer 2120 provided on at least one surface of the base 2110, and at least one internal electrode 2130 provided on the piezoelectric layer 2120. Also, the piezoelectric element 210 may further include cover layers 2140 (2141 and 2142) provided on a surface of a laminate in which a plurality of piezoelectric layers 2120 are laminated and external electrodes 2500 (2510, 2520, 2530, and 2540) provided outside the laminate so as to be selectively connected to the internal electrodes 2130. The piezoelectric element 210 may be provided in a bimorph-type in which the piezoelectric layer 2120 is provided on both surfaces of the base 2110 or an unimorph-type in which the piezoelectric layer 2120 is provided on one surface of the base 2110. Also, the piezoelectric element 210 may be provided in an unimorph-type by laminating a plurality of piezoelectric layers 2120 on one surface of the base 2110 to increase displacement and vibration force and be driven at a low voltage. For example, as illustrated in FIGS. 6 to 9, the plurality of piezoelectric layers 2120 (2121 to 2126) may be laminated on one surface and the other surface of the base 2110, and a conductive layer is provided between the piezoelectric layers 2120 to provide a plurality of internal electrodes 2130 (2131 to 2138). Meanwhile, at least one of the internal electrodes 2130 may be provided on the surface of the base 2110. Here, the base 2110 may be made of an insulating material. Also, the piezoelectric element 210 may further include external electrodes 2140 (2141 and 2142) provided outside the laminate so as to be connected to the internal electrodes 2130.

The base 2110 may use a material having a characteristic maintaining the structure in which the piezoelectric layers 2120 are laminated and generating vibration. For example, the base 2110 may be made of a material such as metal, plastic, and insulating ceramic. Also, the base 2110 may be made of the same kind of material as that of the piezoelectric layer 2120. That is, the base 2110 may be made of a material such as metal, plastic, and insulating ceramic, which is different from that of the piezoelectric layer 2120, or the same kind of material as that of the piezoelectric layer 2120. Here, the piezoelectric layer 2120 used as the base 2110 may not be polarized or may be polarized. When the piezoelectric layer 2120 used as the base 2110 is polarized, the base 2110 may serve as the piezoelectric layer 2120. Also, the base 2110 may have a circular shape in accordance with the shape of the piezoelectric element 210 and include the opening 230 at a central portion thereof. The base 2110 may have a thickness that is one-third to one-one hundred fiftieth of a total thickness of the piezoelectric element 210. For example, the base 2110 may have a thickness of 2 μm to 200 μm. Here, the thickness of the base 2110 may be less than that of all of piezoelectric layers 2120, and equal to or greater than that of each of the plurality of laminated piezoelectric layers 2120. Alternatively, the thickness of the base 2110 may be less than that of each of the piezoelectric layers 2120. However, as the thickness of the base 2110 increases, the thickness of the piezoelectric layers 2120 may decrease or the number of lamination of the piezoelectric layers 2120 may be reduced to generate small amount of piezoelectric phenomenon. Thus, the thickness of the base 2110 is desirably less than that of all of the piezoelectric layers 2120.

Each of the piezoelectric layers 2120 may have the same shape and the same size as those of base 2110. That is, the piezoelectric layer 2120 may have a circular shape and has the opening 230 at a central portion thereof. Here, the opening 230 of the piezoelectric layer 2120 and the opening 230 of the base 2110 may have the same size and shape as each other. Also, the piezoelectric layer 2120 may be laminated in two layers to seventy layers, desirably two layers to fifty layers, more desirably six layers to thirty layers. Here, a sound pressure may be adjusted in accordance with the number of lamination of the piezoelectric layer 2120. That is, as the number of lamination increases, the sound pressure may increase. However, when the piezoelectric layer 2120 is laminated in more than seventy layers, since the piezoelectric element 210 increases in thickness, and the sound pressure slightly increases, the piezoelectric layer 2120 is desirably laminated in two layers to fifty layers, more desirably six layers to thirty layers. Meanwhile, the piezoelectric layer 2120 may be laminated on one surface and the other surface of the base 2110 with the same number. For example, the first to third piezoelectric layers 2121 to 2123 may be laminated on one surface of the base 2110, and the fourth to sixth piezoelectric layers 2124 to 2126 may be laminated on the other surface of the base 2110. Also, each of the piezoelectric layers 2120 may have a thickness of one-third to one-one hundredth of the thickness of the piezoelectric element 210. For example, each of the piezoelectric layers 2120 may have a thickness of 1 μm to 300 μm, desirably 2 μm to 30 μm, more desirably 2 μm to 20 μm. The sound output apparatus including the piezoelectric element 210 may be driven by a voltage provided from an electronic device such as a portable electronic device, e.g., a smartphone. Here, since the voltage provided from the electronic device is too low, i.e., about 0.2 V, the piezoelectric layer 2120 needs to have an approximate thickness to maximize the performance of the piezoelectric element 210. Thus, the thickness of the piezoelectric layer 2120 may be desirably 2 μm to 30 μm, more desirably 2 μm to 20 μm. The piezoelectric layers 2120 may be made of, e.g., a PZT(Pb, Zr, Ti), NKN(Na, K, Nb), or BNT(Bi, Na, Ti)-based piezoelectric material. However, the piezoelectric layers 2120 may not be limited to the above-described materials and may use various piezoelectric materials. That is, the piezoelectric layers 2120 may use various kinds of piezoelectric materials that generate a voltage when pressure is applied thereto and generate increase or decrease in volume or length due to pressure variation when a voltage is applied. Meanwhile, each of the piezoelectric layers 2120 may include a pore (not shown) defined in at least one area thereof. Here, the pore may have at least one size and shape. That is, the pore may have an irregular shape and size and be irregularly distributed. Also, the piezoelectric layer 2120 may be polarized in at least one direction. For example, two adjacent piezoelectric layers 2120 may be polarized in different directions. That is, the plurality of piezoelectric layers 2120 polarized in different directions may be alternately laminated. For example, the first, third, and fifth piezoelectric layers 2121, 2123, and 2125 are polarized in a downward direction, and the second, fourth, and sixth piezoelectric layers 2122, 2124, and 2126 may be polarized in an upward direction.

The internal electrode 2130 may be provided to apply an external voltage to the piezoelectric layers 2120. That is, the internal electrodes 2130 may apply a first power for polarization of the piezoelectric layers 2120 and a second power for driving the piezoelectric layers 2120 to the piezoelectric layers 2120. The first power for polarization and the second power for driving may be applied to the internal electrodes 2130 through the external electrode 2150. These internal electrodes 2130 may be respectively provided between the base 2110 and the plurality of piezoelectric layers 2120. Also, each of the internal electrodes 2130 may have a circular shape in accordance with the shapes of the base 2110 and the piezoelectric layers 2120. Alternatively, the internal electrode 2130 may have a polygonal shape such as a rectangular shape. Here, the internal electrode 2130 may be disposed on an area except for an area on which the opening 230 is defined and spaced a predetermined distance from an edge of the piezoelectric layer 2120. Also, the internal electrode 2130 may be spaced a predetermined distance from the opening 230. Accordingly, the internal electrode 2130 may have a surface area less than that of the piezoelectric layer 2120. Also, the internal electrode 2130 may be selectively connected to the external electrode 2150 disposed outside the laminate in which the piezoelectric layers 2200 are laminated. That is, two internal electrodes 2130 may be connected to one external electrode 2150. For example, as illustrated in FIGS. 6 to 9, the first and third internal electrodes 2131 and 2133 may be connected to a first external electrode 2151, the second and fourth internal electrodes 2132 and 2134 may be connected to a second external electrode 2152, the fifth and seventh internal electrodes 2135 and 2137 may be connected to a third external electrode 21, and the sixth and eighth internal electrodes 2136 and 2138 may be connected to a fourth external electrode 2154. For this, the internal electrodes 2130 may include a lead electrode led in a direction of the external electrodes 2150. That is, each of the internal electrodes 2120 may include a main electrode having an approximately circular shape in accordance with that of the piezoelectric layer 2200 and a lead electrode led in a direction of the external electrodes 2150 with a predetermined width from a predetermined area of the main electrode. In FIGS. 6 to 9, a portion having the same size in a vertical direction of the internal electrodes 2130 is the main electrode, and a portion further extending to be connected to the external electrode 2150 is the lead electrode. Meanwhile, each of the internal electrodes 2130 may be made of a conductive material including, e.g., metal containing at least one of Al, Ag, Au, Pt, Pd, Ni, and Cu or a metallic alloy thereof. In case of an alloy, for example, an alloy of Ag and Pd may be used. Meanwhile, the internal electrode 2130 may have a thickness equal to or less than that of the piezoelectric layer 2120, e.g., a thickness of 1 μm to 10 μm. Here, at least one area of the internal electrode 2130 may have a different thickness, or at least one area may be removed therefrom. That is, the same internal electrodes 2130 may have at least one area having a thickness greater or less than that of another area, or at least one area may be removed from the internal electrode 2130 to expose the piezoelectric layer 2120. However, although at least one area of the internal electrode 2130 has a greater or less thickness or at least one area is removed therefrom, an overall connection state may be maintained not to generate any problem in electrical conductivity. Also, the different internal electrodes 2130 may have thicknesses different from each other in the same area or have shapes different from each other That is, at least one internal electrode 2130 in the same area corresponding to a predetermined length and width in a vertical direction among the plurality of internal electrodes 2130 may have a thickness or a shape different from that of each of the internal electrodes 2130. Here, the different shape may include a shape recessed, protruding, or notched. Also, the each of the internal electrodes 2130 may have a surface area of 10% to 97% of that of each of the piezoelectric layers 2120. Meanwhile, the piezoelectric element 210 may have a distance to the internal electrode 2130, which is one-tenth to one-hundredth of a total thickness. That is, each of the piezoelectric layers 210 between the internal electrodes 2130 may be one-third to one-hundredth of a thickness of all of the piezoelectric elements 210. For example, when each of the piezoelectric elements 210 has a thickness of 300 μm, a distance between the internal electrodes 2130, i.e., a thickness of each of the piezoelectric layers 2120 may be 3 μm to 100 μm. A driving voltage may be varied by the distance between the internal electrodes 2130, i.e., the thickness of the piezoelectric layer 2120, and the driving voltage may decrease as the distance between the internal electrodes 2130 is closer. However, when the distance between the internal electrodes 2130, i.e., the thickness of the piezoelectric layer 2120, exceeds one-third of the total thickness of the piezoelectric elements 210, the driving voltage may increase, and accordingly, a high cost driving IC for generating a higher driving voltage may be necessary to increase costs. Also, when the distance between the internal electrodes 2130, i.e., the thickness of the piezoelectric layer 2120, is less than one-hundredth of the total thickness of the piezoelectric elements 210, thickness variation may frequently occur, and accordingly, the thickness of the piezoelectric layer 2120 may not be constant to decrease characteristics thereof.

The cover layer 2140 may be disposed on at least one of bottom and top surfaces of the laminate. That is, the cover layer 2140 may include at least one of a lower cover layer 2141 disposed on a lower portion of the laminate and an upper cover layer 2142 disposed on an upper portion of the laminate. The cover layer 2140 may be made of an insulating material, e.g., a piezoelectric material that is not polarized. The internal electrodes 2130 may be prevented from being oxidized by the cover layer 2140. That is, the cover layer 2140 may be provided to cover the first and eighth internal electrodes 2131 and 2138 that are exposed to the outside, and oxygen or moisture may be prevented from being introduced by the cover layers 2140 to prevent the oxidation of the internal electrodes 2130.

The external electrodes 2150 may be provided to apply the driving voltage for the piezoelectric layers 2120. For this, the external electrodes 2150 may be provided on at least one surface of the laminate and connected to the internal electrodes 2130. For example, a plurality of external electrodes 2150 may be spaced a predetermined distance from each other on a side surface of the laminate. Alternatively, the external electrodes 2150 may extend on at least one surface of the top and bottom surfaces as well as the side surface of the laminate. The external electrodes 2150 may be provided by using a method such as printing, deposition, sputtering, and plating and provided as at least one layer. For example, in each of the external electrodes 2150, a first layer contacting the laminate may be formed by using a method of printing using a conductive paste, and a second layer disposed thereabove may be formed by a plating method. Also, at least one area of the external electrodes 2150 connected to the internal electrodes 2130 may be made of the same material as that of the internal electrodes 2130. For example, the internal electrode 2130 may be made of copper, and the first layer of the external electrode 2130 contacting the internal electrode 2140 and provided on the surface of the laminate may be made of copper.

Characteristics of the piezoelectric speaker in accordance with the thickness and the number of lamination of the piezoelectric layer 2120 are illustrated in FIGS. 10 and 11. That is, FIG. 10 is a graph showing sound characteristics in accordance with the thickness of the piezoelectric layer, and FIG. 11 is a graph showing sound characteristics in accordance with the number of lamination of the piezoelectric layer.

To compare the sound characteristics in accordance with the thickness of the piezoelectric layer, the sound characteristics are measured when the thickness of the piezoelectric layer is 1 μm, 2 μm, 5 μm, 10 μm, 20 μm, and 30 μm with the same number of lamination. As illustrated in FIG. 10, when the thickness of the piezoelectric layer is 1 μm, the sound characteristics remarkably decreases at an about 6,000 Hz. Also, when the thickness is 2 μm to 30 μm, the sound characteristics are excellent at a frequency equal to or greater than 6,000 Hz. In particular, the sound characteristics increases as the thickness decreases, and the best sound characteristics are shown at the thickness of 2 μm. Also, when the thickness of the piezoelectric layer is 30 μm, the sound characteristics decreases in comparison with those when the thickness is less than 30 μm. Accordingly, the piezoelectric layer have the excellent sound characteristics at the thickness equal to or greater than 2 μm and less than 30 μm.

Also, to compare the sound characteristics in accordance with the number of lamination of the piezoelectric layer, the sound characteristics are measured when the piezoelectric layer is laminated in 5 layers, 10 layers, 30 layers, and 50 layers with the same thickness. As illustrated in FIG. 11, as the number of lamination increases, the sound characteristics increase. That is, when the number of lamination is equal to or greater than 30, the sound characteristics increase in comparison with those when the number of lamination is less than 30.

As a result, the sound characteristics increases as the thickness of the piezoelectric layer 2120 decreases, and the number of lamination of the piezoelectric layer 2120 increases.

2.2. Another Example of the Piezoelectric Element

Meanwhile, the piezoelectric layer 2120 may use a piezoelectric ceramic sintered body produced by sintering an oriented base material composition made of a piezoelectric material and a piezoelectric ceramic composition including a seed composition made of an oxide distributed in the oriented base material composition and having a general formula of ABO₃ ((A indicates a divalent metallic element, B indicates a tetravalent metallic element). That is, the piezoelectric element 210 may include a base 2110 and a piezoelectric layer 2120 and an internal electrode 2130 disposed on at least one surface of the base 2110, and the piezoelectric layer 2120 may include a piezoelectric ceramic sintered body including a seed composition. Here, the oriented base material composition may be made of a piezoelectric material having a perovskite crystal structure. Also, the oriented base material composition may use a composition in which a material having a crystal structure different from the perovskite crystal structure forms a solid solution. For example, a PZT-based material in which PbTiO₃[PT] having a tetragonal structure and PbZrO₃[PZ] having a rhombohedral structure form a solid solution may be used.

Also, the oriented base material composition may use a composition employing at least one of Pb(Ni,Nb)P₃[PNN], Pb(Zn,Nb)O₃[PZN] and Pb(Mn,Nb)O₃[PMN] as a relaxor in the PZT-based material to improve characteristics of the PZT-based material. For example, a PZNN-based material that uses a PZN-based material and a PNN-based material in a PZT-based material to have high piezoelectric characteristics, low dielectric constant, and sinterability is employed as a relaxor to produce the oriented base material composition. The oriented base material composition that employs the PZNN-based material in the PZT-based material as the relaxor may have a compositional formula of (1−x)Pb(Zr_{0.47}Ti_{0.53})O₃-xPb((Ni_{1-y}Zn_{y})_{1/3}Nb_{2/3})O₃. Here, x may have a value within a range of 0.1<x<0.5, desirably a value within a range of 0.30≤x≤0.32, most desirably a value of 0.31. Here, x may have a value within a range of 0.1<x<0.5, desirably a value within a range of 0.30≤x≤0.41, more desirably a value of 0.40.

Since a piezoelectric ceramic sintered body shows remarkable increase in piezoelectric characteristics in an area of a morphotropic phase boundary (MPB), composition near the MPB is necessary to be found. As composition of the oriented base material composition that is sintered by adding a seed composition has a phase different from that when the seed composition is not added, and forms a new MPB composition in accordance with an amount of addition of the seed composition, the excellent piezoelectric characteristics may be induced. The MPB composition may be adjusted by changing a value of x and a value of y. The MPB composition is most desirable when x has a value of 0.31 and y has a value of 0.40 because the MPB composition has the highest piezoelectric characteristics and dielectric characteristics.

Also, the oriented base material composition may use an unleaded piezoelectric material that does not include lead (Pb). The unleaded piezoelectric material may include at least one piezoelectric material selected from the group consisting of Bi_{0.5}K_{0.5}TiO₃, Bi_{0.5}Na_{0.5}TiO₃, K_{0.5}Na_{0.5}NbO₃, KNbO₃, NaNbO₃, BaTiO₃, (1−x)Bi_{0.5}Na_{0.5}TiO₃-xSrTiO₃, (1−x)Bi_{0.5}Na_{0.5}TiO₃-xBaTiO₃, (1−x)K_{0.5}Na_{0.5}NbO₃-xBi_{0.5}Na_{0.5}TiO₃, and BaZr_{0.25}Ti_{0.75}O₃.

The seed composition is formed of an oxide having a general formula of ABO₃. Here, ABO₃ is an oxide having a perovskite structure having orientation and a plate shape, where A indicates a divalent metallic element and B indicates a tetravalent metallic element. The seed composition produced by the oxide having the general formula of ABO₃ may include at least one of CaTiO₃, BaTiO₃, SrTiO₃, PbTiO₃, and Pb(Ti,Zr)O₃ and be improved in piezoelectric performance when BaTiO₃ is used for the seed composition. When BaTiO₃ is used for the seed composition, BaTiO₃ may be produced by synthesizing Bi₄Ti₃O₁₂ that is an aurivillius-type templated structure in a molten salt synthesis method and substituting through topochemical microcrystal conversion (TMC). Here, the seed composition may be contained at a volume ratio of 1 vol % to 10 vol % with respect to the oriented base material composition. When the seed composition is contained in the oriented raw material composition with less than 1 vol %, an effect by which crystal orientation is improved by the seed composition is insignificant, and when greater than 10 vol %, the piezoelectric performance of the piezoelectric ceramic sintered body decreases. Here, when the seed composition is contained in the oriented base material composition with 10 vol %, a strain amount may be maximized to have optimized piezoelectric characteristics.

The piezoelectric ceramic composition including the oriented base material composition and the seed composition is grown to have the same orientation as that of the seed composition by templated grain growth (TGG). That is, since as BaTiO₃ is used as the seed composition in the oriented base material composition having a composition formula of 0.69Pb(Zr_{0.47}Ti_{0.53})O₃-0.31Pb((Ni_{0.6}Zn_{0.4})_{1/3}Nb_{2/3})O₃, sintering may be performed even at a low temperature, the crystal orientation may be improved, and the strain amount may be maximized, the piezoelectric ceramic sintered body may have the high piezoelectric characteristics that is similar to those of a single crystal material, That is, as the seed composition improving the crystal orientation is added to the oriented base material composition and then sintered to produce the piezoelectric ceramic sintered body, the strain amount in accordance with an electric field may be maximized, and the piezoelectric characteristics may be remarkably improved.

Also, the piezoelectric ceramic sintered body in accordance with another exemplary embodiment may have a Lotgering factor having a value equal to or greater than 85%.

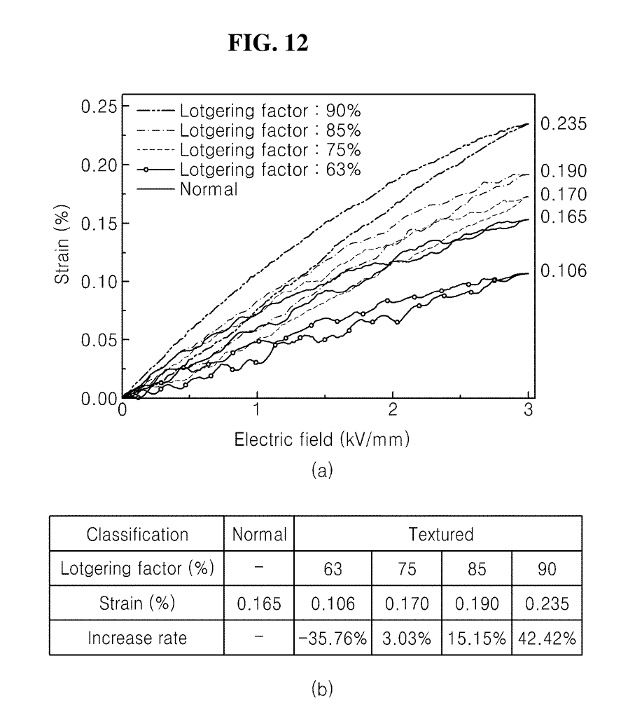

(a) of FIG. 12 is a graph showing a strain rate in accordance with an electric field per Lotgering factor, and (b) of FIG. 12 is a table showing an increase rate of the strain rate per the Lotgering factor. Also, FIG. 11 is a graph showing a piezoelectric constant d33 in accordance with the Lotgering factor.

Referring to FIG. 12, the piezoelectric ceramic sintered body increases in strain rate as the Lotgering factor increases. That is, in case of the piezoelectric ceramic sintered body (Normal), in which the crystal orientation is not performed, the strain rate in accordance with the electric field has a value of 0.165%. When the crystal orientation increases by the templated grain growth with respect to the piezoelectric ceramic sintered body, the strain rate decreases to 0.106% by about 35.76% in the piezoelectric ceramic sintered body, and as a value of the Lotgering factor increases to 75%, 85%, and 90%, the strain rate also increases to 0.170%, 0.190%, and 0.235%.

When the Lotgering factor of the piezoelectric ceramic sintered body has the value equal to or greater than 85% with respect to the maximum value 100%, the increase rate in accordance with the electric field remarkably increases. That is, when the Lotgering factor of the piezoelectric ceramic sintered body increases from 75% to 85%, the increase rate has a value of about 12%. However, when the Lotgering factor of the piezoelectric ceramic sintered body increases from 85% to 90%, the increase rate has a value of about 27%, i.e., more than about four times.

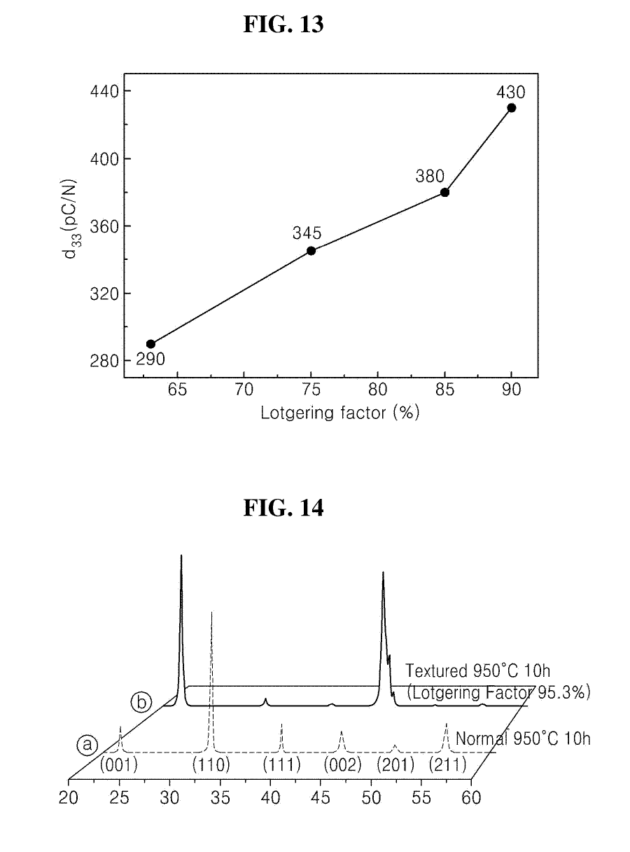

Also, when the piezoelectric ceramic sintered body has a value equal to or greater than 85%, the value of the piezoelectric constant d33 remarkably increases. The piezoelectric constant d33 represents an amount of an electric charge generated in a pressure direction when a pressure is applied to a material. As the piezoelectric constant d33 has a higher value, high accuracy piezoelectric element having an excellent sensitivity may be produced. As illustrated in FIG. 13, when the Lotgering factor of the piezoelectric ceramic sintered body increases from 75% to 85%, the piezoelectric constant d33 increases from 345 pC/N to 380 pC/N by 35 pC/N. However, when the Lotgering factor of the piezoelectric ceramic sintered body increases from 85% to 90%, the piezoelectric constant d33 increases from 380 pC/N to 430 pC/N by 50 pC/N, which is more than three times increase rate. Accordingly, in case of the piezoelectric ceramic sintered body in accordance with an exemplary embodiment, as the piezoelectric ceramic sintered body is produced by the oriented base material composition made of the piezoelectric material having the perovskite crystal structure and the seed composition made of the oxide distributed in the oriented base material composition and having the general formula of ABO₃ (A indicates a divalent metallic element, B indicates a tetravalent metallic element), the piezoelectric ceramic sintered body having the Lotgering factor equal to or greater than 85% may be produced, and the piezoelectric element having the improved strain rate and the high sensitivity may be produced.

Characteristics (embodiment) of the piezoelectric layer with the seed composition included in accordance with an exemplary embodiment is compared with the piezoelectric layer without the seed composition included. For the exemplary embodiment, powder of PbO, ZrO₂, TiO₂, ZnO, NiO, Nb₂O₅, which have more than 98% purity, is used to synthesize the oriented base material composition of 0.69Pb(Zr_{0.47}Ti_{0.53})O₃-0.31Pb((Ni_{0.6}Zn_{0.4})_{1/3}Nb_{2/3})O₃. Also, Bi₄Ti₃O₁₂ that is an Orbilius templated structure is synthesized in a molten salt synthesis method, and a BaTiO₃ seed composition is synthesized through a structural chemical microcrystal substitution. The seed composition is mixed in the oriented base material composition with 10 vol % and then injected and molded to produce a piezoelectric specimen. Also, the piezoelectric specimen increases in temperature by 5° C. per minute to perform a sintering process at a temperature of 950° C. for 10 hours. In comparison, the comparative example is produced as same as the exemplary embodiment except that BaTiO₃ is not added as the seed composition. That is, since BaTiO₃ is not added in the comparative example, the piezoelectric specimen without the seed composition is produced.

FIG. 14 is a graph showing each of the piezoelectric ceramic sintered bodies of the comparative example and the exemplary embodiment, i.e., x-ray diffraction patterns of the piezoelectric specimen □ of the comparative example and the piezoelectric specimen □ of the exemplary embodiment. In the graph, a degree of orientation is calculated in accordance with a calculation formula of the Lotgering factor, and description regarding the calculation formula for calculating the Lotgering factor and the specific process will be omitted. As illustrated in FIG. 14, the piezoelectric specimen □ of the comparative example is grown in all crystal directions on a surface thereof, and the crystal is remarkably grown in a normal direction of a plane 110. Meanwhile, in the piezoelectric specimen □ of the exemplary embodiment, crystal is grown in only a normal direction of a plane 002 that is the same direction of a normal direction of a plane 001 on a surface thereof, and the crystal growth is restrained in the normal direction of the plane 110. Also, a height of the graph represents an intensity of an x-ray peak, and the Lotgering factor has a value of 95.3% in case of the piezoelectric specimen □ of the exemplary embodiment. Through this, in the piezoelectric ceramic sintered body including the seed composition, the orientation is grown in the direction 001, and thus the crystal orientation is remarkably improved.

FIG. 15 is an image illustrating a scan electron microscope image of the piezoelectric ceramic sintered body. That is, (a) of FIG. 15 is a cross-sectional image of the piezoelectric specimen produced by the comparative example, and (b) of FIG. 15 is a cross-sectional image of the piezoelectric specimen produced by the exemplary embodiment. As illustrated in (a) of FIG. 15, in case of the piezoelectric ceramic sintered body without the seed composition added, a grain is grown to have a hexagonal shape. This result coincident with the result of FIG. 9, in which the crystal is grown in each of plural planar directions. Meanwhile, as illustrated in (b) of FIG. 15, the piezoelectric ceramic sintered body with the seed composition added is grown to have a rectangular shape by the seed composition (black area in (b) of FIG. 15) that is horizontally disposed, so that the crystal orientation is improved.

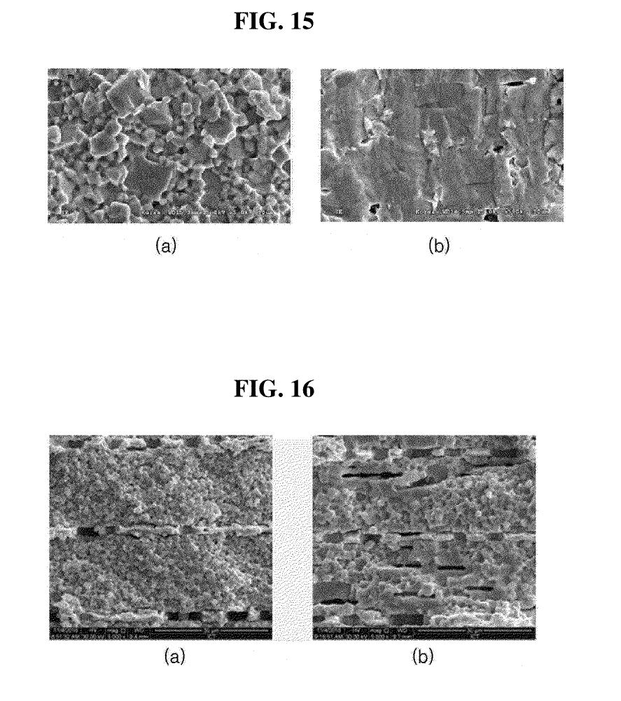

Also, FIG. 16 is a cross-sectional image of the piezoelectric element using the piezoelectric ceramic sintered body as the piezoelectric layer. That is, (a) of FIG. 16 is a cross-sectional image of the piezoelectric specimen using the piezoelectric ceramic sintered body as the piezoelectric layer in accordance with the comparative example, and (b) of FIG. 16 is a cross-sectional image of the piezoelectric specimen using the piezoelectric ceramic sintered body as the piezoelectric layer in accordance with the exemplary embodiment. As illustrated in (b) of FIG. 16, the seed composition (black area in (b) of FIG. 16) exists in the piezoelectric element using the exemplary embodiment, and as illustrated in (a) of FIG. 16, the seed composition does not exist in the piezoelectric element using the comparative example. Here, the seed may be oriented to have a length of 1 μm to 50 μm in one direction. That is, the orientation degree of the seed may be oriented with about 1 μm to 50 μm respectively in one direction and at least another direction, desirably 5 μm to 20 μm, more desirably 7 μm to 10 μm.

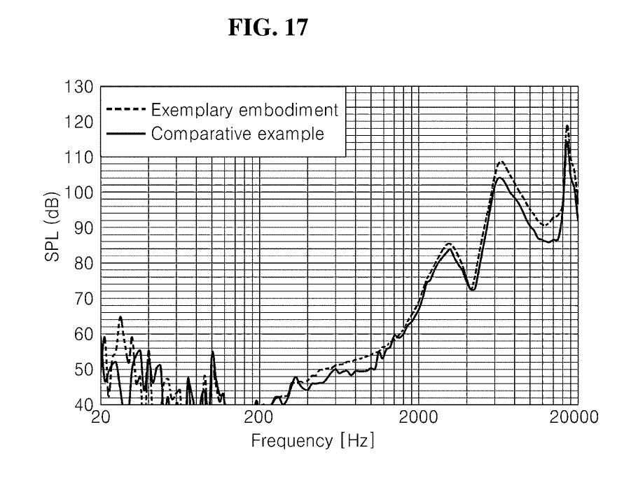

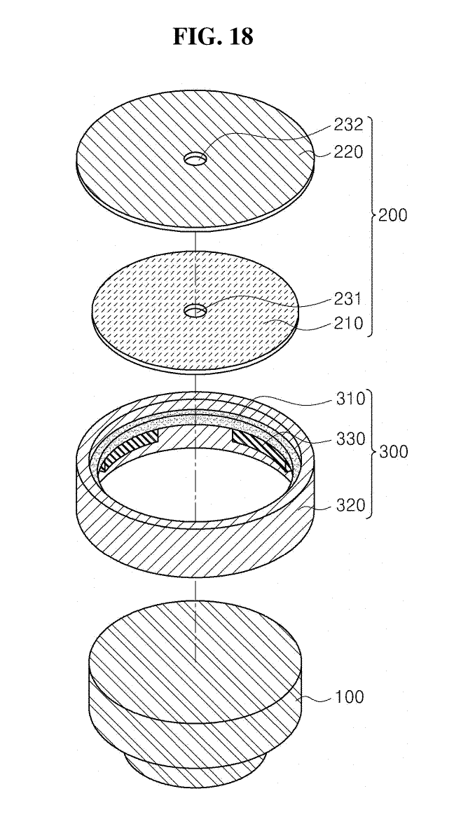

FIG. 17 is a graph showing sound characteristics of the sound output unit including the piezoelectric element using the piezoelectric ceramic sintered body as the piezoelectric layer. As illustrated in FIG. 17, the exemplary embodiment with the seed composition added is improved in sound characteristics in comparison with the comparative example without the seed composition added. That is, the sound pressure is improved by more than 3 dB in a high-pitched band equal to or greater than 200 Hz.

Another Exemplary Embodiment of Sound Output Apparatus

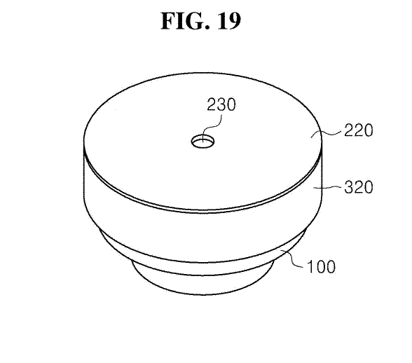

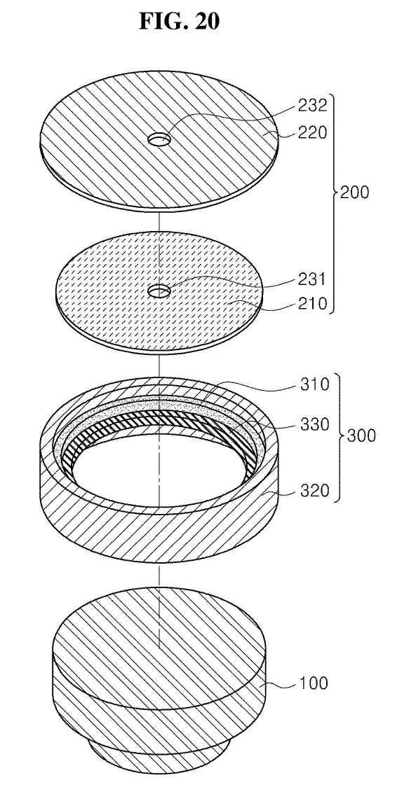

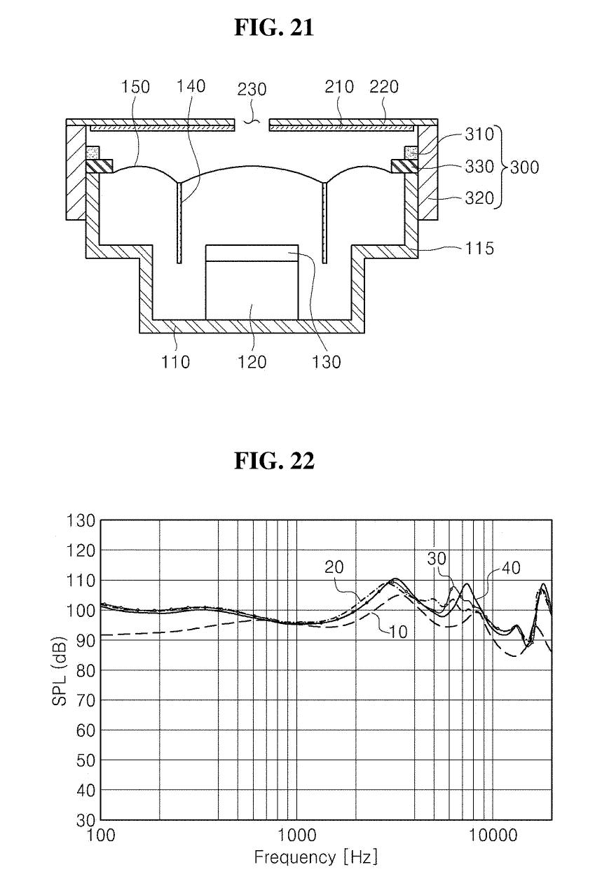

FIG. 18 is an exploded perspective view of a sound output apparatus in accordance with another exemplary embodiment, and FIG. 19 is a coupling perspective view of a sound output apparatus in accordance with another exemplary embodiment Also, FIG. 20 is an exploded perspective view of a sound output apparatus in accordance with still another exemplary embodiment, and FIG. 21 is a coupling cross-sectional view thereof.

Referring to FIGS. 18 through 21, the sound output apparatus in accordance with another and still another exemplary embodiments may include a first sound output part 100 including a voice coil 140 and a vibration member 150, a second sound part 200 disposed on the first sound output part 100 and including a piezoelectric element 210, a vibration plate 220, and an opening 230, and a housing 300 accommodating at least one of the first and second sound output units 100 and 200. Here, in accordance with another and still another exemplary embodiments, the piezoelectric element 210 may be disposed below the vibration plate 220 to realize the second sound output unit 200, i.e., a piezoelectric speaker. That is, in accordance with an exemplary embodiment, the second sound output unit 200 may be formed in such a manner that the piezoelectric element 210 is disposed inside or outside the housing 300.

Also, as illustrated in FIGS. 20 and 21, the housing 300 may include a first member 310 having a ring shape, a second member 320 surrounding the first member 310, and a protruding part 330 disposed below the first member 310. Here, the protruding part 330 may have a ring shape like the first member 310. Also, the protruding part 330 may be less in size than an internal diameter of the first member 310. Accordingly, the first member 310 may have a diameter greater than that of the protruding part 330, and accordingly, a stair-shaped stepped portion may be provided between the first member 310, the protruding part 330, and the second member 320. That is, the first member 310 may have the diameter greater than that of the protruding part 330, and the second member 320 may have the diameter greater than that of the first member 310. Here, the second sound output unit 200 is seated on the first member 310, and the first sound output unit 100 is coupled below the protruding part 330. That is, the first sound output unit 100 and the second sound output unit 200 may be spaced apart from each other with the first member 310 and the protruding part 330 therebetween. Alternatively, the second sound output unit 200 may be seated on the protruding part 330. That is, the first and second sound output units 100 and 200 may be spaced apart from each other with the protruding part 330 therebetween.

As described above, the sound output apparatus in accordance with exemplary embodiments may include the first sound output unit 100 and the second sound output unit 200 in the housing 300 to improve low-pitched sound and high-pitched sound output characteristics. That is, as the first sound output unit 100, i.e., the dynamic speaker, having excellent low-pitched characteristics and the second sound output unit 200, i.e., the piezoelectric speaker, having excellent high-pitched characteristics are disposed in the housing 300, the sound characteristics in the audio frequency band may be improved. Here, the sound output apparatus in accordance with an exemplary embodiment may output a frequency of 20 Hz to 60 kHz. Also, as the opening 230 is defined in the second sound output unit 200, the sound of the first sound output unit 100 may be outputted through the opening 230. Accordingly, the sound is outputted from the second sound output unit 200, and then the sound is outputted from the first sound output unit 100 through the opening 230, so that the two sounds are mixed outside the housing 300. As the two sounds are mixed outside the housing 300, a sound quality may be improved in comparison with a case in which sounds are mixed in the housing 300.

Also, in the sound output apparatus in accordance with an exemplary embodiment, since at least one opening 230 is defined in the second sound output unit 200, the housing may be reduced in size, and thus, the total size of the sound output apparatus may be reduced. That is, according to Korean Patent Application No. 2015-0171719 applied for a patent by the present applicant, since a discharge hole is necessarily defined in a predetermined area of a housing to discharge an output sound of a dynamic speaker, the housing is limited to be reduced in size. However, in accordance with an exemplary embodiment, since a separate sound discharge hole is not defined in the housing 300, and the sound of the first sound output unit 100 is discharged through the opening 230 defined in the second sound output unit 200, the housing may be reduced in size. That is, while the piezoelectric element 210 of the second sound output unit 200 is maintained, the external diameter of the housing 300 may be reduced in size. As illustrated in FIG. 3, the external diameter A of the housing 300 may be 20% of the diameter B of the piezoelectric element 210. In other words, when the diameter B of the piezoelectric element 210 is 100, the external diameter A of the housing 300 may be equal to or greater than 100 and less than 130, desirably, greater than 100 and equal to or less than 125, more desirably, equal to or greater than 105 and equal to or less than 120. Here, when the diameter B of the piezoelectric element 210 is equal to the external diameter A of the housing, the piezoelectric element 210 and the vibration plate have the same size, and a diameter of the vibration plate 220 is equal to the external diameter of the housing 300. However, since an acoustic conversion effect and an amplification effect of the vibration plate 220 is reduced when the piezoelectric element 210 and the vibration plate 220 have the same size as each other, the vibration plate 220 is necessarily greater in size than the piezoelectric element 210, and desirably, the vibration plate 220 is greater in size by about 5% than the piezoelectric element 210. Accordingly, since the diameter of the vibration plate 220 is equal to the external diameter of the housing 300, when the diameter of the piezoelectric element 210 is 100, the external diameter of the housing 300 is desirably equal to or greater than 105. Also, when the external diameter of the housing 300 is greater by 30% than the diameter of the piezoelectric element 210, an effect in size reduction of the sound output apparatus is reduced, so that the external diameter of the housing 300 is desirably equal to or less than 20% of the diameter of the piezoelectric element 210. Resultantly, when the diameter of the piezoelectric element 210 is 100, the external diameter of the housing 300 is desirably 105 to 120. For example, when the diameter B of the piezoelectric element 210 is 10 mm, the external diameter A of the housing 300 may be 10.5 mm to 12 mm. Here, since the diameter of the vibration plate 220 may have the same size as the external diameter of the housing 300, when the diameter of the piezoelectric element 210 is 10 mm, the external diameter A of the housing and the diameter of the vibration plate 220 may be 10.5 mm to 12 mm. However, in Korean Patent Application No. 2015-0171719 applied for a patent by the present applicant, the diameter of the piezoelectric element 210 is greater by 30% than the external diameter of the housing 300. For example, when the diameter of the piezoelectric element 210 is 10 mm, the external diameter of the housing 300 according to Korean Patent Application No. 2015-0171719 may be about 13 mm. This is because the sound of the first sound output unit 100 is outputted through the discharge hole defined in the housing 300. Accordingly, in accordance with an exemplary embodiment, while the diameter of the piezoelectric element 210 is maintained as it is, the external diameter of the housing 300 may be reduced in comparison with other inventions. For example, the external diameter of the housing may be reduced by 10% to 20%. That is, when the external diameter of the housing 300 in accordance with other inventions is 100, the external diameter of the housing 300 in accordance with an exemplary embodiment may be 80 to 90. Resultantly, in accordance with an exemplary embodiment, the diameter of the piezoelectric element 210 may be maintained as it is, the external diameter of the housing 300 may be reduced, and thus the size of the sound output apparatus may be reduced. Meanwhile, when the size of the piezoelectric element 210 is reduced, the size of the housing 300 may be further reduced. That is, it is described that the size of the housing 300 is 10.5 mm to 13 mm when the size of the piezoelectric element 210 is 10 mm in the above-described exemplary embodiment. However, the size of the piezoelectric element 210 may be equal to or less than 10 mm, and accordingly, the size of the housing 300 may be less than 13 mm. Accordingly, in accordance with an exemplary embodiment, the size of the housing 300 may be less than 13 mm, e.g., equal to or greater than 8 mm and less than 13 mm regardless of the size of the piezoelectric element 210.

Table. 1 shows an opening in various sizes, an area ratio according thereto, and sound characteristics of the sound output apparatus using the same. Here, experiments are performed under a condition in which the piezoelectric element 210 has a circular shape having a diameter of 10 mm, and the opening has a size of 0.1 mm to 9 mm. Also, the opening having a circular shape is defined in a central area of the piezoelectric element, and the opening is also defined in the vibration plate at the same position with the same size as that of the piezoelectric element 210. Meanwhile, in the table. 1, “X” is marked when the sound characteristics are degraded, “O” is marked when similar to that of the related art, and “⊚” is marked when improved in comparison with that of the related art. As described in the table. 1, when the diameter of the opening is 0.3 mm to 7 mm with respect to the piezoelectric element having a diameter of 10 mm, i.e., a size ratio is 3% to 70% or an area ratio is 0.09% to 50%, the sound characteristics are similar or improved in comparison with those of the conventional sound output apparatus. In particular, when a size ratio of the opening to the piezoelectric element 10% to 20%, or an area ratio thereof is 1% to 4%, the sound characteristics are improved in comparison with those of the related art. The sound characteristics further improved than those of the related art is compared with the sound characteristics of the related art and illustrated in FIG. 22.

TABLE 1

| Size of opening (mm) | Ratio of size (%) | Ratio of area (%) | Result |
|---|---|---|---|
| 0.1 | 1 | 0.01 | X |
| 0.3 | 3 | 0.09 | 0 |
| 0.5 | 5 | 0.25 | 0 |
| 1 | 10 | 1 | ⊚ |
| 1.5 | 15 | 2.25 | ⊚ |
| 2 | 20 | 4 | ⊚ |
| 3 | 30 | 9 | ⊚ |
| 4 | 40 | 16 | 0 |
| 5 | 50 | 25 | 0 |
| 6 | 60 | 36 | 0 |
| 7 | 70 | 49 | 0 |
| 8 | 80 | 64 | X |
| 9 | 90 | 81 | X |

FIG. 22 is a graph illustrating characteristics of a sound output apparatus in which an opening is defined in a piezoelectric speaker in accordance with exemplary embodiments and a sound output apparatus in which a discharge hole is defined in a housing in accordance with a comparative example. Here, the housing having an external diameter of 13 mm and the piezoelectric element having a diameter of 10 mm, and the dynamic speaker are applied together in the comparative example, and the housing having an external diameter of 11.2 mm and the piezoelectric element having a diameter of 10 mm, and the dynamic speaker are applied together in an exemplary embodiment. Also, the sound output hole having a size of 10 mm is defined in the housing in the comparative example, and the opening having one of diameters of 1 mm, 1.5 mm, and 2 mm is defined in the central portion of the second sound output unit in the exemplary embodiment. In FIG. 22, the reference numeral 10 is a characteristic graph in accordance with the comparative example, and the reference numerals 20, 30, and 40 are characteristic graphs when the opening having one of diameters of 1 mm, 1.5 mm, and 2 mm is defined in the central portion of the second sound output unit in accordance with the exemplary embodiment. As illustrated in FIG. 22, the sound output apparatuses 20, 30, and 40 in accordance with an exemplary embodiment, in which the piezoelectric speaker, i.e., the piezoelectric element and the vibration plate, is defined, have the higher sound characteristics in a frequency equal to or greater than 2000 Hz than those of the sound output apparatus 10 in accordance with the comparative example in which the opening is not defined in the piezoelectric speaker and the discharge hole is defined in the housing. Also, in a frequency equal to or greater than 2500 Hz, as the diameter of the opening increases, the sound characteristics increase. That is, in a frequency equal to or greater than 2500 Hz, the sound characteristics in case that the opening having the diameter of 2 mm is defined are greater than those in case that each of the openings having the diameters of 1.5 mm and 1 mm is defined, and the sound characteristics are higher in case that the opening having the diameter of 1.5 mm is defined than those in case that the opening having the diameter of 1 mm is defined. Accordingly, it is noted that the sound output apparatus, in which the opening is defined in the piezoelectric speaker, in accordance with an exemplary embodiment have the further improved sound characteristics than the sound output apparatus in which the discharge hole is defined in the housing. Also, the sound characteristics in a specific frequency range may be improved in accordance with the size of the opening. That is, the sound characteristics may be adjusted improved in accordance with the size of the opening.

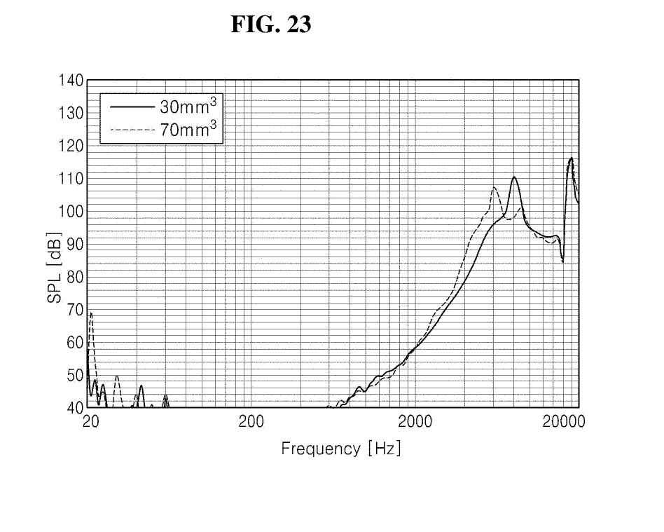

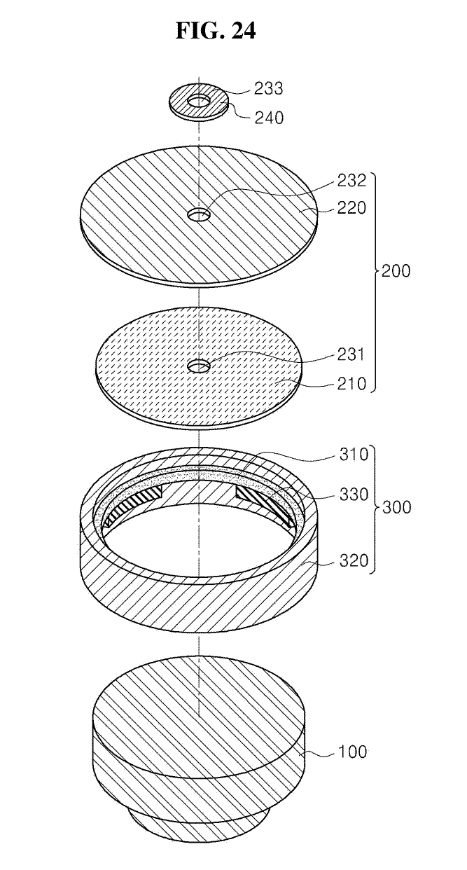

Also, FIG. 23 is a graph showing characteristics of the piezoelectric speaker in accordance with a volume of a space between the dynamic speaker and the piezoelectric speaker. That is, as illustrated in FIG. 3, the sound characteristics of the second sound output unit 200 in accordance with the volume of the inner space C defined between the first and second sound output units 100 and 200 by the housing 300 are compared and illustrated in FIG. 23. As illustrated in FIG. 23, the sound characteristics are measured when the volume of the inner space is 30 mm³ and 70 mm³, and as the volume of the inner space increases, the resonant frequency of the second sound output unit 200, i.e., the piezoelectric speaker, may be shifted to a low frequency band. For example, when the volume of the inner space is 30 mm³, the resonant frequency is 8,000 Hz, and when the volume of the inner space is 70 mm³, the resonant frequency is 6,000 Hz. Accordingly, as the volume of the space between the dynamic speaker and the piezoelectric speaker increases, the resonant frequency of the piezoelectric speaker may be shifted to the low frequency band.

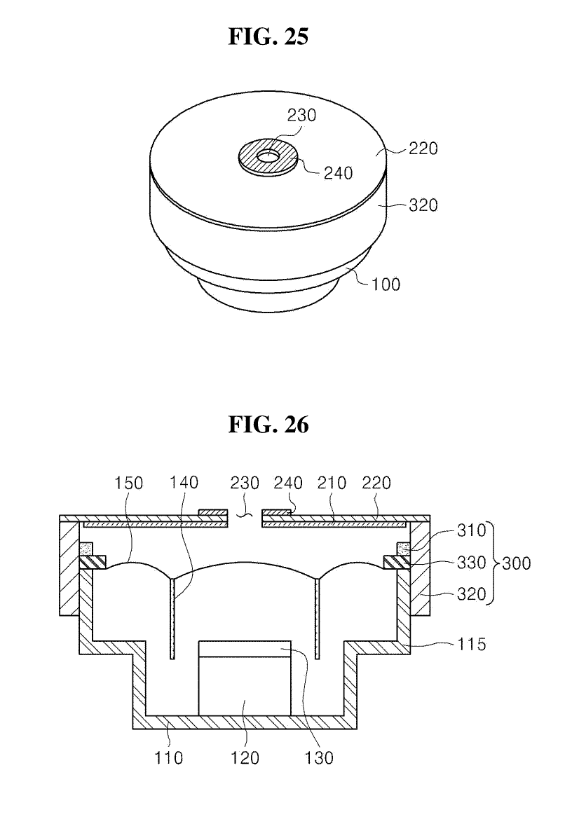

Meanwhile, the sound output apparatus in accordance with an exemplary embodiment may further include a weight member 240 disposed on at least one area of the second sound output unit 200. For example, as illustrated in FIGS. 24 to 26, the sound output apparatus in accordance with even another exemplary embodiment may further include the weight member 240 disposed on at least one surface of the vibration plate 220. That is, the piezoelectric element 210 may be disposed on one surface of the vibration plate 220, and the weight member 240 may be provided on the other surface thereof. Alternatively, the weight member 240 may be disposed on the piezoelectric element 210. That is, the piezoelectric element 210 may be disposed on one surface of the vibration plate 220, and the weight member 240 may be provided on the other surface thereof. Here, the weight member 240 may be fixed on the vibration plate 220 or the piezoelectric element 210 by using a predetermined adhesion member. The adhesion member may include a tape or an adhesive such as a double sided tape, a cushion tape, an epoxy adhesive, a silicone adhesive, and a silicone pad. Also, the weight member 240 may not block the opening 230. That is, an opening 233 may be defined in the weight member 240 to correspond to openings 231 and 232 respectively defined in the piezoelectric element 210 and the vibration plate 220 Here, the opening 233 define din the weight member 240 may have the same size and shape as those of each of the openings 231 and 232 respectively defined in the piezoelectric element 210 and the vibration plate 220 or greater in size than the piezoelectric element 210 and the vibration plate 220. That is, the opening 233 equal to or greater than each of the openings 231 and 232 may be defined in the weight member 240 so that at least a portion of the opening 230 is not blocked by the weight member 240. Alternatively, the weight member 240 may be disposed on an area spaced apart from the opening 230.

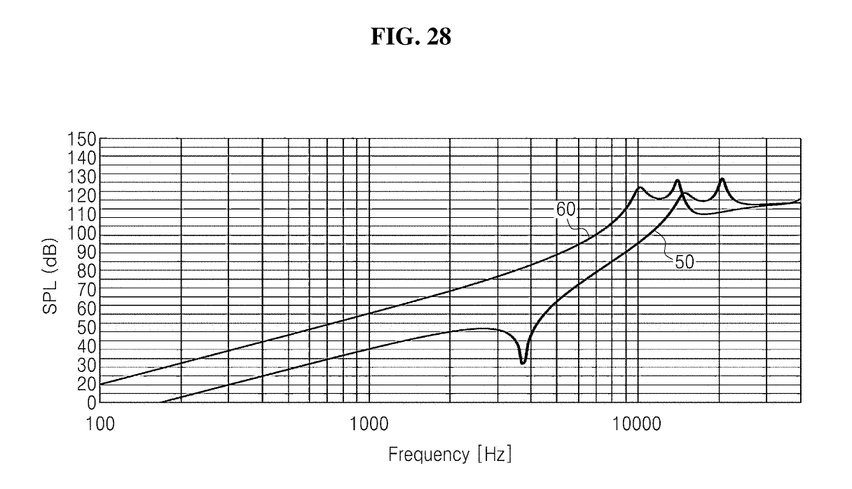

The weight member 240 may be made of a material having a predetermined mass such as a metallic material. For example, the weight member 240 may be made of a metallic material such as SUS and tungsten that have a mass equal to or grater than that of the piezoelectric element 210. As the weight member 240 having a predetermined mass is provided on at least a portion of the second sound output unit 200, a weight is loaded on the second sound output unit 200. Accordingly, the vibration body, i.e., the piezoelectric element 210 and/or the vibration element 220, increases in weight as a result, and thus, the sound characteristics may be further improved in comparison with those when the weight member 240 is not used. That is, FIG. 28 is a graph showing comparison between the sound characteristics of a comparative example 50, in which the piezoelectric element 210 and the vibration plate, which have the same size as each other, are used, and the weight member 240 is not provided, and an exemplary embodiment 60, in which the weight member 240 is provided. The sound characteristics may be improved in the same frequency in the exemplary embodiment 60 in comparison with the comparative example 50. Accordingly, when the weight member 240 is provided, the piezoelectric element 210 may be reduced in size and the same sound characteristics as those when the size of the piezoelectric element 210 is not reduced may be realized. That is, as the weight member 240 is provided, the piezoelectric element 210 having a second diameter less than a first diameter may have the sound characteristics that is the same as or similar to those of the piezoelectric element 210 having the first diameter. As a result, when the weight member 240 is provided, the resonant frequency may decrease, and accordingly, the size of the second sound output unit 200, in particular, the size of the piezoelectric element 210, may be reduced to reduce the total size of the sound output apparatus in accordance with the exemplary embodiment. That is, the diameter of the piezoelectric element 210 may be reduced, and accordingly, the external diameter of the housing 300 may be reduced. Here, the resonant frequency may be adjusted in accordance with the size and mass of the weight member 240, and accordingly, the diameter of the sound output apparatus, i.e., the external diameter of the housing 300 may be reduced by about 8 mm, more desirably, about 6 mm. That is, the sound output apparatus in accordance with the exemplary embodiment may have the external diameter of about 6 mm to about 13 mm.

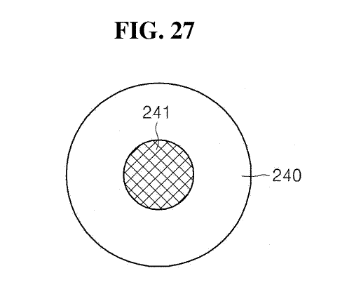

Meanwhile, as illustrated in FIG. 27, a mesh structure may be provided on the opening 233 of the weight member 240. That is, the mesh structure may be made of the same material as that of a portion contacting the vibration plate 220 and provided on the opening 233. Here, the characteristics of the first sound output unit 100 may be adjusted in accordance with a size of a pore of the mesh. Here, the frequency characteristics of about 20 Hz to about 1 kHz may be adjusted in accordance with a size of a pore 241 of the mesh. For example, the sound pressure may increase in the frequency band when the size of the pore 241 is small, and the sound pressure may decrease in the frequency band when the size of the pore 241 is big.

As described above, as the weight member 240 is provided on at least one area of the second sound output unit 200, the resonant frequency of the piezoelectric element 210 may decrease. Accordingly, the size of the piezoelectric element 210 may be reduced at the same resonant frequency, and thus, the total size of the sound output apparatus may be reduced.

As described above, the technical idea of the present disclosure has been specifically described with respect to the above embodiments, but it should be noted that the foregoing embodiments are provided only for illustration while not limiting the present disclosure. Various embodiments may be provided to allow those skilled in the art to understand the scope of the preset invention, but the present disclosure is not limited thereto.

1. A sound output apparatus comprising:
a first sound output unit;
a second sound output unit spaced a predetermined distance from the first sound output unit; and
a housing configured to accommodate at least one of the first and second sound output units,
wherein at least one of the first and second sound output units comprises a piezoelectric element in which a plurality of piezoelectric layers are laminated, and the piezoelectric element is formed in at least one of manners that the piezoelectric layer has a thickness that is ⅓ to 1/100 of that of the piezoelectric element, and the laminated number of the piezoelectric layers is 2 to 50.

2. The sound output apparatus of claim 1, wherein the other of the first and second sound output units is a dynamic speaker and disposed in the housing.

3. The sound output apparatus of claim 1, further comprising at least one opening defined in the piezoelectric element.

4. The sound output apparatus of claim 3, wherein the at least one opening has a diameter that is 3% to 70% of that of the piezoelectric element.

5. The sound output apparatus of claim 1, wherein an external diameter of the housing is 100% to 130% of a diameter of the piezoelectric element.

6. The sound output apparatus of claim 5, further comprising a vibration plate provided on one surface of the piezoelectric element and having an external diameter that is equal to or less than that of the housing.

7. The sound output apparatus of claim 6, wherein the vibration plate is seated on an upper portion of the housing.

8. The sound output apparatus of claim 1, wherein the piezoelectric element comprises a plurality of piezoelectric layers, a plurality of internal electrodes provided between the plurality of piezoelectric layers, and an external electrode provided at the outside in order to be connected to the plurality of internal electrodes.

9. The sound output apparatus of claim 8, wherein each of the piezoelectric layers has a thickness of 2 μm to 50 μm.

10. (canceled)

11. (canceled)

12. The sound output apparatus of claim 8, wherein each of the piezoelectric layers has a thickness equal to or greater than that of an internal electrode.

13. The sound output apparatus of claim 8, wherein the piezoelectric layer comprises at least one pore.

14. The sound output apparatus of claim 8, wherein an internal electrode has at least one area having a different thickness.

15. The sound output apparatus of claim 8, wherein an internal electrode has a surface area that is 10% to 97% of that of the piezoelectric layer.

16. The sound output apparatus of claim 1, wherein the piezoelectric layer comprises a seed composition.

17. The sound output apparatus of claim 1, wherein the piezoelectric layer comprises an oriented base material composition made of a piezoelectric material having a perovskite crystal structure and a seed composition made of an oxide distributed in the oriented base material composition and having a general formula of ABO₃ (A indicates a divalent metallic element, and B indicates a tetravalent metallic element).

18. The sound output apparatus of claim 16 or 17, wherein the seed composition is oriented with a length of 1 μm to 50 μm in at least one direction.

19. The sound output apparatus of claim 1, further comprising a weight member disposed on at least one area of the second sound output unit.

20. The sound output apparatus of claim 1, wherein the first and second sound output units are driven at the same voltage of approximately 0.1V to approximately 5V.

21. The sound output apparatus of claim 1, wherein a space between the first and second sound output units has a volume of 10 mm³ to 100 mm³.

22. The sound output apparatus of any one of claims 1 to 9, 12-17, 19, and 21, further comprising a coating layer disposed on at least a portion of at least one of the first sound output unit, the second sound output unit, and the housing.
